(19) United States
(12) Patent Application Publication
(10) Pub. No.: US 2026/0371386 A1
(43) Pub. Date: Nov. 19, 2026

(54) CHANNEL OCCUPANCY TIME SHARING IDENTIFIERS

(71) Applicant: QUALCOMM Incorporated, San Diego, CA (US)

(72) Inventors: Siyi CHEN, Beijing (CN); Jing SUN, San Diego, CA (US); Xiaoxia ZHANG, San Diego, CA (US); Chih-Hao LIU, San Diego, CA (US); Changlong XU, Beijing (CN); Shaozhen GUO, Beijing (CN); Luanxia YANG, Beijing (CN); Hao XU, Beijing (CN); Giovanni CHISCI, San Diego, CA (US)

(21) Appl. No.: 19/132,150

(22) PCT Filed: Jan. 16, 2023
(86) PCT No.: PCT/CN2023/072249

§ 371 Date: May 22, 2025

(51) Int. Cl. H04W 74/0808

(52) U.S. Cl. CPC H04W 74/0808

(57) ABSTRACT

Various aspects of the present disclosure generally relate to wireless communication. In some aspects, a first user equipment (UE) may establish, using a listen-before-talk (LBT) procedure, a channel occupancy time (COT) having a set of shareable resources. The UE may transmit, to a second UE, COT sharing information indicating the set of shareable resources to be shared with the second UE, the COT sharing information comprising a first COT sharing identifier (ID), the first COT sharing ID indicating a first unicast mode source ID associated with the first UE and a first unicast mode destination ID associated with the second UE, the first unicast mode destination ID identifying the second UE as eligible for sharing the set of shareable resources. Numerous other aspects are described.

### FIELD OF THE DISCLOSURE

Aspects of the present disclosure generally relate to wireless communication and to techniques and apparatuses for using channel occupancy time sharing identifiers.

### BACKGROUND

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and types of wireless communications mediums available for use, and the like. Consequently, there exists a need for further improvements in wireless communications systems to overcome the aforementioned technical challenges and others.

### SUMMARY

One aspect provides a method for wireless communication by a first user equipment (UE). The method includes establishing, using a listen-before-talk (LBT) procedure, a channel occupancy time (COT) having a set of shareable resources; and transmitting, to a second UE, COT sharing information indicating the set of shareable resources to be shared with the second UE, the COT sharing information comprising a first COT sharing identifier (ID), the first COT sharing ID indicating a first unicast mode source ID associated with the first UE and a first unicast mode destination ID associated with the second UE, the first unicast mode destination ID identifying the second UE as eligible for sharing the set of shareable resources.

Another aspect provides a method for wireless communication by a second UE. The method includes receiving, from a first UE, COT sharing information indicating a set of shareable resources, of a COT initiated by the first UE, to be shared with the second UE, the COT sharing information comprising a first COT sharing ID, the first COT sharing ID indicating a first unicast mode source ID associated with the first UE and a first unicast mode destination ID associated with the second UE, the first unicast mode destination ID identifying the second UE as eligible for sharing the set of shareable resources; and communicating using the set of shareable resources based on the COT sharing information.

Another aspect provides a method for wireless communication by a first UE. The method includes establishing, using an LBT procedure, a COT having a set of shareable resources; and transmitting COT sharing information indicating the set of shareable resources, the COT sharing information comprising a first COT sharing ID that indicates a first group destination ID associated with a first group of one or more eligible COT sharing UEs.

Another aspect provides a method for wireless communication by a second UE. The method includes receiving, from a first UE, COT sharing information indicating a set of shareable resources, of a COT initiated by the first UE, to be shared with the second UE, the COT sharing information comprising a first COT sharing ID that indicates a first group destination ID associated with a first group of one or more eligible COT sharing UEs, the first group including the second UE; and communicating using the set of shareable resources based on the COT sharing information.

Other aspects provide: an apparatus operable, configured, or otherwise adapted to perform any one or more of the aforementioned methods and/or those described herein with reference to and as illustrated by the drawings and specification; a non-transitory, computer-readable medium comprising computer-executable instructions that, when executed by a processor of an apparatus, cause the apparatus to perform the aforementioned methods and/or those described herein with reference to and as illustrated by the drawings and specification; a computer program product embodied on a computer-readable storage medium comprising code for performing the aforementioned methods and/or those described herein with reference to and as illustrated by the drawings and specification; and/or an apparatus comprising means for performing the aforementioned methods and/or those described herein with reference to and as illustrated by the drawings and specification. By way of example, an apparatus may comprise a processing system, a device with a processing system, or processing systems cooperating over one or more networks.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 depicts an example of a wireless communications network, in accordance with the present disclosure.

FIG. 2 depicts aspects of an example base station (BS) and user equipment (UE), in accordance with the present disclosure.

FIG. 3 depicts an example disaggregated base station architecture, in accordance with the present disclosure.

FIGS. 4A, 4B, 4C, and 4D depict aspects of data structures for a wireless communications network, such as wireless communications network of FIG. 1, in accordance with the present disclosure.

FIGS. 5A-5C depict examples of sidelink communications, in accordance with the present disclosure.

FIG. 6 depicts an example associated with channel occupancy time sharing identifiers, in accordance with the present disclosure.

FIG. 7 shows a method for wireless communications by a first UE.

FIG. 8 shows a method for wireless communications by a second UE.

FIG. 9 shows a method for wireless communications by a first UE.

FIG. 10 shows a method for wireless communications by a second UE.

FIG. 11 is a diagram illustrating an example of an implementation of code and circuitry for a communications device, in accordance with the present disclosure.

### DETAILED DESCRIPTION

Aspects of the present disclosure provide apparatuses, methods, processing systems, and computer-readable mediums for channel occupancy time (COT) sharing identifiers (IDs).

Some aspects described herein relate to an unlicensed radio frequency spectrum band, which may be used for communications in a wireless network. The unlicensed radio frequency spectrum band can be used in a cellular network in combination with, or independent from, a licensed radio frequency spectrum band. In some examples, the unlicensed radio frequency spectrum band can be a radio frequency spectrum band for which a device may need to contend for access because the radio frequency spectrum band is available, at least in part, for unlicensed use, such as Wi-Fi use. Prior to gaining access to, and communicating over, an unlicensed sidelink radio frequency spectrum band, a transmitting user equipment (UE) can perform a listen-before-talk (LBT) procedure to contend for access to the unlicensed radio frequency spectrum band. An LBT procedure can include determining whether a channel of the unlicensed sidelink radio frequency spectrum band is available. If the LBT procedure is successful, the transmitting UE may gain access to the unlicensed channel for a duration that may be referred to as a COT, during which the transmitting UE can perform transmissions without performing additional LBT operations.

In some cases, a wireless network may enable a COT obtained by a COT initiator UE to be shared with other UEs in order to improve access and efficiency for an unlicensed channel. The term “COT initiator UE” can refer to a UE that initiates (which may be interchangeably referred to as “acquires”) a COT in a shared radio frequency band (e.g., in a shared spectrum or an unlicensed spectrum) for sidelink communication. Sharing a COT includes sharing shareable resources of a COT. The COT initiator UE can share the COT with eligible COT sharing UEs. An eligible COT sharing UE is a UE that is eligible to share a COT acquired by an initiating UE. The COT initiator UE can transmit COT sharing information to an eligible COT sharing UE (e.g., a receiving UE). The COT sharing information may indicate shareable resources of the COT and/or other information that the receiving UE may use to facilitate sharing the COT. In some cases, the COT sharing information can indicate a respective layer 1 ID (e.g., a sidelink layer 1 source ID or a sidelink layer 1 destination ID) associated with each of the COT initiator UE and the receiving UE. Each UE also may include a sidelink layer 2 source ID and a sidelink layer 2 destination ID associated with sidelink communications.

To facilitate more efficient sidelink communications in cases in with shareable resources of a COT are shared between UEs, the COT sharing information may include one or more COT sharing IDs. The COT sharing IDs are additional IDs to the sidelink layer 1 IDs and/or sidelink layer 2 IDs. The COT sharing IDs can indicate eligible COT sharing UEs. For example, the COT sharing ID can include a COT sharing destination ID associated with the receiving UE. Since a sidelink source ID of the COT initiator UE can be different across different unicast sessions or cast types, it can be possible that the receiving UE may not use the sidelink source ID as a destination ID for transmitting to the COT initiator UE within the COT. For example, when a receiving UE is not a target receiver of the COT initiator UE's data transmission, the receiving UE can be unable to identify the COT initiator UE as the COT initiator, resulting in failure of the receiving UE to identify the COT initiator UE as a receiver of a transmission from the receiving UE within the shared COT, which can lead to inefficiencies in transmissions within a shared COT, missed transmissions within a shared COT, and/or a failure to successfully share the COT, thereby negatively impacting network performance.

Some aspects of the techniques and apparatuses described herein provide COT sharing IDs for facilitating identification of an initiator UE as well as eligible COT sharing UEs. For example, in some aspects, a first UE may establish (e.g., acquire) a COT via an LBT procedure. The first UE may transmit COT sharing information indicating shareable resources of the COT. The COT sharing information also may indicate a COT sharing ID. The COT sharing ID may include a source ID associated with the first UE and a destination ID associated with a second UE. The destination ID may indicate the second UE as an eligible COT sharing UE. In some aspects, the COT sharing ID may include a unicast mode source ID and a unicast mode destination ID, which may facilitate unicast communications within the shared COT. In some aspects, truncated source IDs and/or destination IDs may be used to reduce the payload size of the COT sharing ID. In some aspects, the first UE may configure a table, via PC-5 radio resource control (RRC) signaling, that includes a table ID (which may relate to an application layer ID of an application layer associated with the sidelink communications) and a mapping between a set of table indices and ID pairs. The COT sharing ID may indicate the table ID and one or more table indices. In this way, the second UE may identify whether the second UE is an eligible COT sharing UE via the table. The second UE also may identify the first UE as the COT initiator UE via the table.

In some aspects, the COT sharing ID may include a common destination ID (a “group destination ID”) to indicate a group of eligible COT sharing UEs, rather than indicating a distinct COT sharing destination ID associated with each eligible COT sharing UE, thereby indicating eligible COT sharing UEs without increasing the COT sharing ID payload as much as distinct COT sharing destination IDs would. The group of eligible COT sharing UEs may include a group of UEs configured for groupcast communications with the COT initiator UE. In some aspects, for example, the COT sharing ID may include a group COT initiator ID associated with the COT initiator UE. In some aspects, the group destination ID may be a groupcast mode destination ID while, in some other aspects, the group destination ID may be unrelated to groupcast mode communications. In some aspects, the COT sharing ID may include one or more unicast mode IDs (e.g., one or more unicast source IDs or unicast destination IDs) in addition to one or more group destination IDs.

In some aspects, the COT initiator UE may configure one or more groups for COT sharing. For example, the COT initiator UE may transmit PC-5 RRC configuration information that configures the one or more groups of UEs. The UEs belonging to a configured group may be eligible for sharing a COT with the COT initiator UE. The COT sharing ID may include a group destination ID associated with the group of UEs and a global COT initiator ID. Each group may include one or more UEs and may be mutually exclusive with another group or may at least partially overlap with another group. In some aspects, the COT sharing ID may include the group destination ID and a bitmap that indicates the eligible COT sharing UEs within the group.

By including a COT sharing source ID as well as the COT sharing destination ID, a receiving UE may identify a transmitting UE as a COT initiator UE of a shared COT. Identification of the COT initiator UE by a receiving UE may facilitate communication from the receiving UE to the COT initiator UE within the shared COT, which may result in more efficient transmissions within the shared COT, a lower likelihood of missed transmissions within the shared COT, and/or a lower likelihood of unsuccessful attempts to share the COT, thereby positively impacting network performance.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

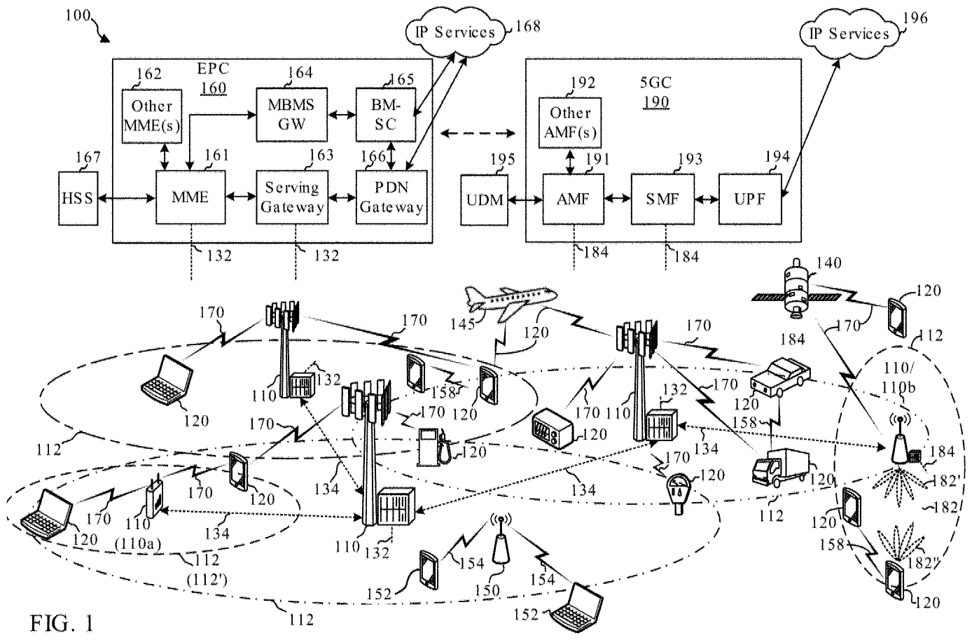

FIG. 1 depicts an example of a wireless communications network 100, in accordance with the present disclosure.

Generally, wireless communications network 100 includes various network entities (alternatively, network elements or network nodes). A network entity is generally a communications device and/or a communications function performed by a communications device (e.g., a UE, a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 110), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 110, UEs 120, and one or more core networks, such as an Evolved Packet Core (EPC) 160 and 5G Core (5GC) 190, which interoperate to provide communications services over various communications links, including wired and wireless links.

FIG. 1 depicts various example UEs 120, which may include a cellular phone, a smart phone, a session initiation protocol (SIP) phone, a laptop, a personal digital assistant (PDA), a satellite radio, a global positioning system (GPS), a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an internet of things (IOT) device, an always on (AON) device, an edge processing device, or another similar device. A UE 120 may also be referred to as a mobile device, a wireless device, a wireless communication device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, or a handset, among other examples.

BSs 110 may wirelessly communicate with (e.g., transmit signals to or receive signals from) UEs 120 via communications links 170. The communications links 170 between BSs 110 and UEs 120 may carry uplink (UL) (also referred to as reverse link) transmissions from a UE 120 to a BS 110 and/or downlink (DL) (also referred to as forward link) transmissions from a BS 110 to a UE 120. The communications links 170 may use multiple-input and multiple-output (MIMO) antenna technology, including spatial multiplexing, beamforming, and/or transmit diversity in various aspects.

A BS 110 may include, for example, a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point, and/or others. A BS 110 may provide communications coverage for a respective geographic coverage area 112, which may sometimes be referred to as a cell, and which may overlap in some cases (e.g., a small cell provided by a BS 110a may have a coverage area 112′ that overlaps the coverage area 112 of a macro cell). A BS 110 may, for example, provide communications coverage for a macro cell (covering a relatively large geographic area), a pico cell (covering a relatively smaller geographic area, such as a sports stadium), a femto cell (covering a relatively smaller geographic area (e.g., a home)), and/or other types of cells.

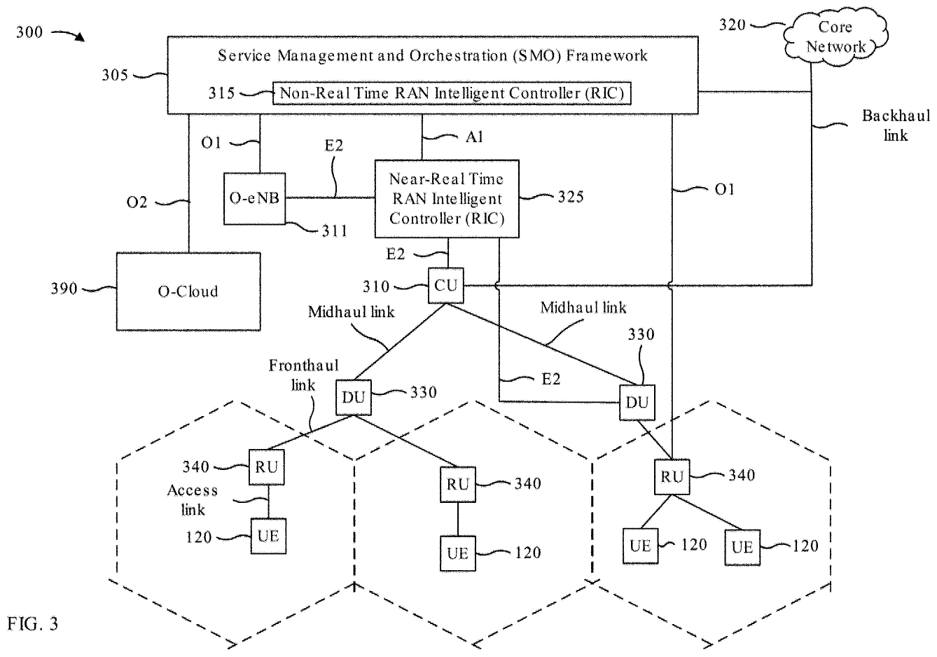

While BSs 110 are depicted in various aspects as unitary communications devices, BSs 110 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a BS (e.g., BS 110) may include components that are located at a single physical location or components located at various physical locations. In examples in which a BS includes components that are located at various physical locations, the various components may each perform functions such that, collectively, the various components achieve functionality that is similar to a BS that is located at a single physical location. In some aspects, a BS including components that are located at various physical locations may be referred to as having a disaggregated radio access network architecture, such as an Open radio access network (RAN) (O-RAN) architecture or a Virtualized RAN (VRAN) architecture. FIG. 3 depicts and describes an example disaggregated BS architecture.

Different BSs 110 within wireless communications network 100 may also be configured to support different radio access technologies, such as 3G, 4G, and/or 5G, among other examples. For example, BSs 110 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 110 configured for 5G (e.g., 5G NR or Next Generation RAN (NG-RAN)) may interface with 5GC 190 through second backhaul links 184. BSs 110 may communicate directly or indirectly (e.g., through the EPC 160 or 5GC 190) with each other over third backhaul links 134 (e.g., X2 interfaces), which may be wired or wireless.

Wireless communications network 100 may subdivide the electromagnetic spectrum into various classes, bands, channels, or other features. In some aspects, the subdivision is based on wavelength and frequency, where frequency may also be referred to as a carrier, a subcarrier, a frequency channel, a tone, or a subband. For example, the 3rd Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mm Wave”). A base station configured to communicate using mmWave or near mmWave radio frequency bands (e.g., a mmWave base station such as BS 110b) may utilize beamforming (e.g., as shown by 182) with a UE (e.g., 120) to improve path loss and range.

The communications links 170 between BSs 110 and, for example, UEs 120, may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. In some examples, allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 110b in FIG. 1) may utilize beamforming with a UE 120 to improve path loss and range, as shown at 182. For example, BS 110b and the UE 120 may each include a plurality of antennas, such as antenna elements, antenna panels, and/or antenna arrays to facilitate the beamforming. In some cases, BS 110b may transmit a beamformed signal to UE 120 in one or more transmit directions 182′. UE 120 may receive the beamformed signal from the BS 110b in one or more receive directions 182″. UE 120 may also transmit a beamformed signal to the BS 110b in one or more transmit directions 182″. BS 110b may also receive the beamformed signal from UE 120 in one or more receive directions 182′. BS 110b and UE 120 may then perform beam training to determine the best receive and transmit directions for each of BS 110b and UE 120. Notably, the transmit and receive directions for BS 110b may or may not be the same. Similarly, the transmit and receive directions for UE 120 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 120 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 161, other MMEs 162, a Serving Gateway 163, a Multimedia Broadcast Multicast Service (MBMS) Gateway 164, a Broadcast Multicast Service Center (BM-SC) 165, and/or a Packet Data Network (PDN) Gateway 166, such as in the depicted example. MME 161 may be in communication with a Home Subscriber Server (HSS) 167. MME 161 is a control node that processes the signaling between the UEs 120 and the EPC 160. Generally, MME 161 provides bearer and connection management.

Generally, user Internet protocol (IP) packets are transferred through Serving Gateway 163, which is connected to PDN Gateway 166. PDN Gateway 166 provides UE IP address allocation as well as other functions. PDN Gateway 166 and the BM-SC 165 are connected to IP Services 168, which may include, for example, the Internet, an intranet, an IP Multimedia Subsystem (IMS), a Packet Switched (PS) streaming service, and/or other IP services.

BM-SC 165 may provide functions for MBMS user service provisioning and delivery. BM-SC 165 may serve as an entry point for content provider MBMS transmission, may be used to authorize and initiate MBMS Bearer Services within a public land mobile network (PLMN), and/or may be used to schedule MBMS transmissions. MBMS Gateway 164 may distribute MBMS traffic to the BSs 110 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 191, other AMFs 192, a Session Management Function (SMF) 193, and a User Plane Function (UPF) 194. AMF 191 may be in communication with Unified Data Management (UDM) 195.

AMF 191 is a control node that processes signaling between UEs 120 and 5GC 190. AMF 191 provides, for example, quality of service (QOS) flow and session management.

IP packets are transferred through UPF 194, which is connected to the IP Services 196, and which provides UE IP address allocation as well as other functions for 5GC 190. IP Services 196 may include, for example, the Internet, an intranet, an IMS, a PS streaming service, and/or other IP services.

In various aspects, a network entity or network node can be implemented as an aggregated base station, a disaggregated base station, a component of a base station, an integrated access and backhaul (IAB) node, a relay node, a sidelink node, a transmission reception point (TRP), or a combination thereof, to name a few examples.

As indicated above, FIG. 1 is provided as an example. Other examples may differ from what is described with regard to FIG. 1.

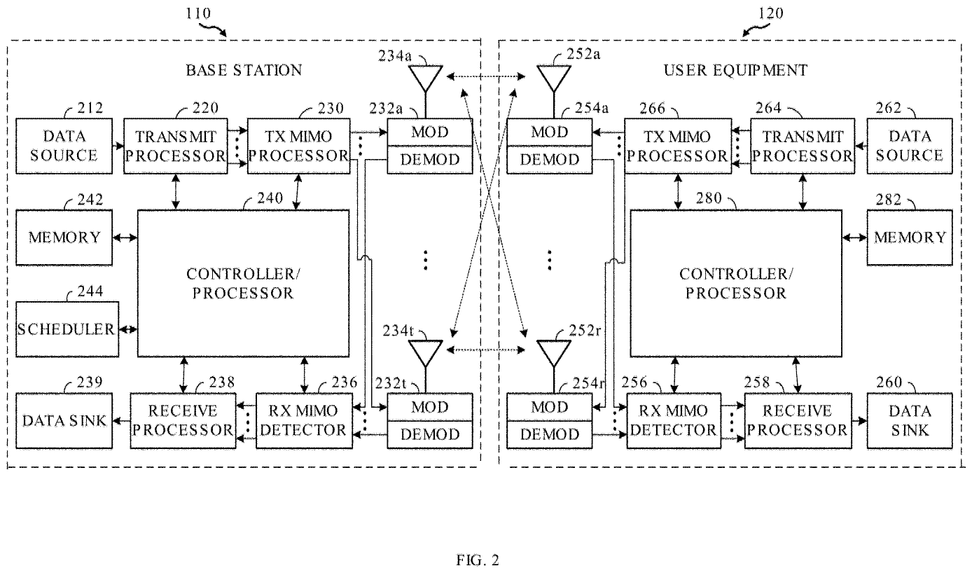

FIG. 2 depicts aspects of an example BS 110 and UE 120, in accordance with the present disclosure.

Generally, BS 110 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, BS 110 may send and receive data between BS 110 and UE 120. BS 110 includes controller/processor 240, which may be configured to implement various functions described herein related to wireless communications.

Generally, UE 120 includes various processors (e.g., 258, 264, 266, and 280), antennas 252a-r (collectively 252), transceivers 254a-r (collectively 254), which include modulators and demodulators, and other aspects, which enable wireless transmission of data (e.g., retrieved from data source 262) and wireless reception of data (e.g., provided to data sink 260). UE 120 includes controller/processor 280, which may be configured to implement various functions described herein related to wireless communications.

For an example downlink transmission, BS 110 includes a transmit processor 220 that may receive data from a data source 212 and control information from a controller/processor 240. The control information may be for the physical broadcast channel (PBCH), the physical control format indicator channel (PCFICH), the physical hybrid automatic repeat request (HARQ) indicator channel (PHICH), the physical downlink control channel (PDCCH), the group common PDCCH (GC PDCCH), and/or other channels. The data may be for the physical downlink shared channel (PDSCH), in some examples.

Transmit processor 220 may process (e.g., encode and symbol map) the data and control information to obtain data symbols and control symbols, respectively. Transmit processor 220 may also generate reference symbols, such as for the primary synchronization signal (PSS), the secondary synchronization signal (SSS), the PBCH demodulation reference signal (DMRS), or the channel state information reference signal (CSI-RS).

Transmit (TX) MIMO processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

UE 120 includes antennas 252a-252r that may receive the downlink signals from the BS 110 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 120 to a data sink 260, and provide decoded control information to a controller/processor 280.

For an example uplink transmission, UE 120 further includes a transmit processor 264 that may receive and process data (e.g., for the PUSCH) from a data source 262 and control information (e.g., for the physical uplink control channel (PUCCH)) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 110.

At BS 110, the uplink signals from UE 120 may be received by antennas 234a-234t, processed by the demodulators in transceivers 232a-232t, detected by a MIMO detector 236 if applicable, and further processed by a receive processor 238 to obtain decoded data and control information sent by UE 120. Receive processor 238 may provide the decoded data to a data sink 239 and the decoded control information to the controller/processor 240. Memories 242 and 282 may store data and program codes (e.g., processor-executable instructions, computer-executable instructions) for BS 110 and UE 120, respectively. Scheduler 244 may schedule UEs for data transmission on the downlink and/or uplink.

In various aspects, BS 110 may be described as transmitting and receiving various types of data associated with the methods described herein. In these contexts, “transmitting” may refer to various mechanisms of outputting data, such as outputting data from data source 212, scheduler 244, memory 242, transmit processor 220, controller/processor 240, TX MIMO processor 230, transceivers 232a-t, antenna 234a-t, and/or other aspects described herein. Similarly, “receiving” may refer to various mechanisms of obtaining data, such as obtaining data from antennas 234a-t, transceivers 232a-t, receive (RX) MIMO detector 236, controller/processor 240, receive processor 238, scheduler 244, memory 242, a network interface, and/or other aspects described herein.

In various aspects, UE 120 may likewise be described as transmitting and receiving various types of data associated with the methods described herein. In these contexts, “transmitting” may refer to various mechanisms of outputting data, such as outputting data from data source 262, memory 282, transmit processor 264, controller/processor 280, TX MIMO processor 266, transceivers 254a-t, antenna 252a-t, and/or other aspects described herein. Similarly, “receiving” may refer to various mechanisms of obtaining data, such as obtaining data from antennas 252a-t, transceivers 254a-t, RX MIMO detector 256, controller/processor 280, receive processor 258, memory 282, and/or other aspects described herein.

In some aspects, a processor may be configured to perform various operations, such as those associated with the methods described herein, and transmit (output) data to or receive (obtain) data from another interface that is configured to transmit or receive, respectively, the data.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an O-RAN (such as the network configuration sponsored by the O-RAN Alliance), or a VRAN, also known as a cloud radio access network (C-RAN) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 depicts an example disaggregated base station 300 architecture. The disaggregated base station 300 architecture may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340, as well as the Near-RT RICs 325, the Non-RT RICs 315 and the SMO Framework 305) may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include RRC, packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the El interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over-the-air (OTA) communications with one or more UEs 120. In some implementations, real-time and non-real-time aspects of control and user plane communications with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an Ol interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, artificial intelligence/machine learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as Al policies).

As indicated above, FIG. 3 is provided as an example. Other examples may differ from what is described with regard to FIG. 3.

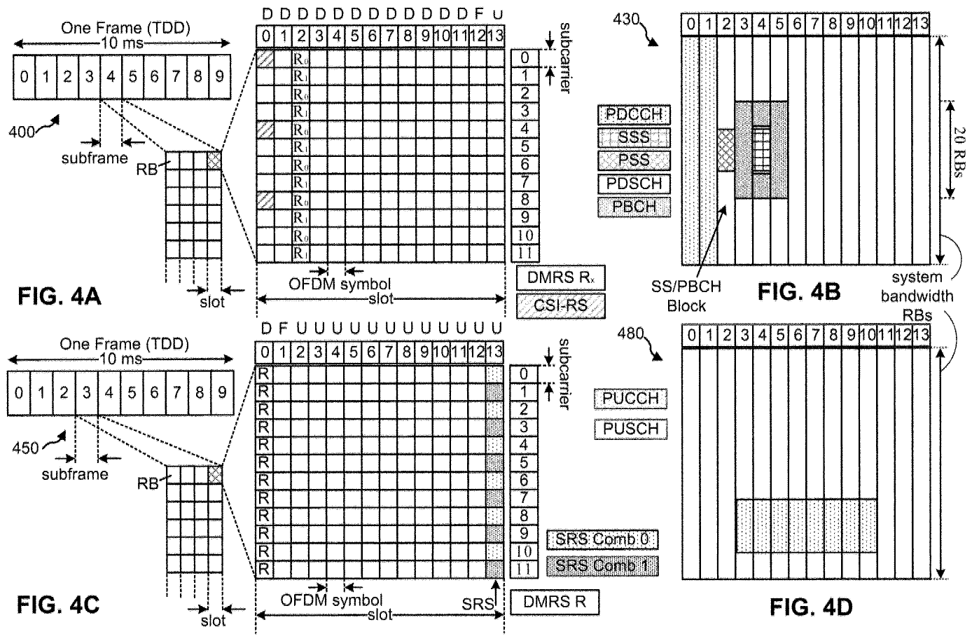

FIGS. 4A, 4B, 4C, and 4D depict aspects of data structures for a wireless communications network, such as wireless communications network 100 of FIG. 1, in accordance with the present disclosure. FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplexed, in which, for a particular set of subcarriers, subframes within the set of subcarriers are dedicated for both DL and UL.

In FIGS. 4A and 4C, the wireless communications frame structure is TDD where D is DL, U is UL, and F is flexible for use between DL/UL. UEs may be configured with a slot format through a received slot format indicator (SFI) (dynamically through DL control information (DCI), or semi-statically/statically through RRC signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 24 slots/subframe. The subcarrier spacing and symbol length/duration are a function of the numerology. The subcarrier spacing may be equal to 2^{μ}×15 kHz, where μ is the numerology index, which may be selected from values 0 to 5. Accordingly, the numerology μ=0 has a subcarrier spacing of 15 kHz and the numerology μ=5 has a subcarrier spacing of 480 kHz. Other numerologies and subcarrier spacings may be used. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RSs) for a UE (e.g., UE 120). The RSs may include DMRSs and/or CSI-RSs for channel estimation at the UE. The RSs may also include beam measurement RSs (BRSs), beam refinement RSs (BRRSs), and/or phase tracking RSs (PT-RSs).

FIG. 4B illustrates an example of various DL channels within a subframe of a frame. The PDCCH carries DCI within one or more control channel elements (CCEs), each CCE including, for example, nine RE groups (REGs), each REG including, for example, four consecutive REs in an OFDM symbol.

A PSS may be within symbol 2 of particular subframes of a frame. The PSS is used by a UE (e.g., UE 120) to determine subframe/symbol timing and a physical layer identity.

An SSS may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRSs. The PBCH, which carries a master information block (MIB), may be logically grouped with the PSS and SSS to form a synchronization signal (SS)/PBCH block (SSB). The MIB provides a number of RBs in the system bandwidth and a system frame number (SFN). The PDSCH carries user data, broadcast system information not transmitted through the PBCH such as system information blocks (SIBs), and/or paging messages.

As illustrated in FIG. 4C, some of the REs carry DMRSs (indicated as R for one particular configuration, but other DMRS configurations are possible) for channel estimation at the base station. The UE may transmit DMRSs for the PUCCH and DMRSs for the PUSCH. The PUSCH DMRSs may be transmitted, for example, in the first one or two symbols of the PUSCH. The PUCCH DMRSs may be transmitted in different configurations depending on whether short or long PUCCHs are transmitted and depending on the particular PUCCH format used. UE 120 may transmit SRSs. The SRSs may be transmitted, for example, in the last symbol of a subframe. The SRSs may have a comb structure, and a UE may transmit SRSs on one of the combs. The SRSs may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

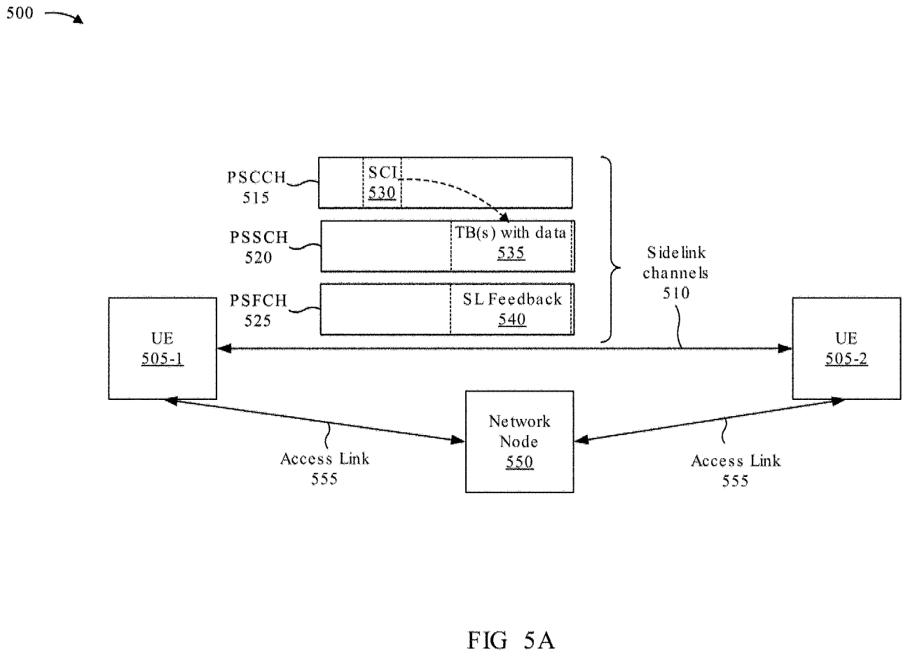

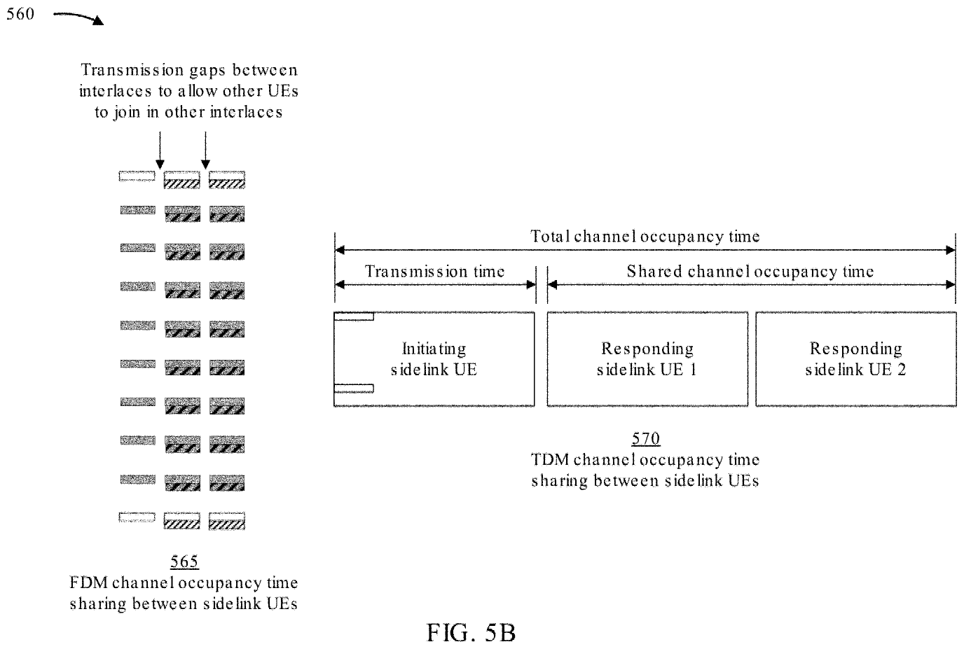

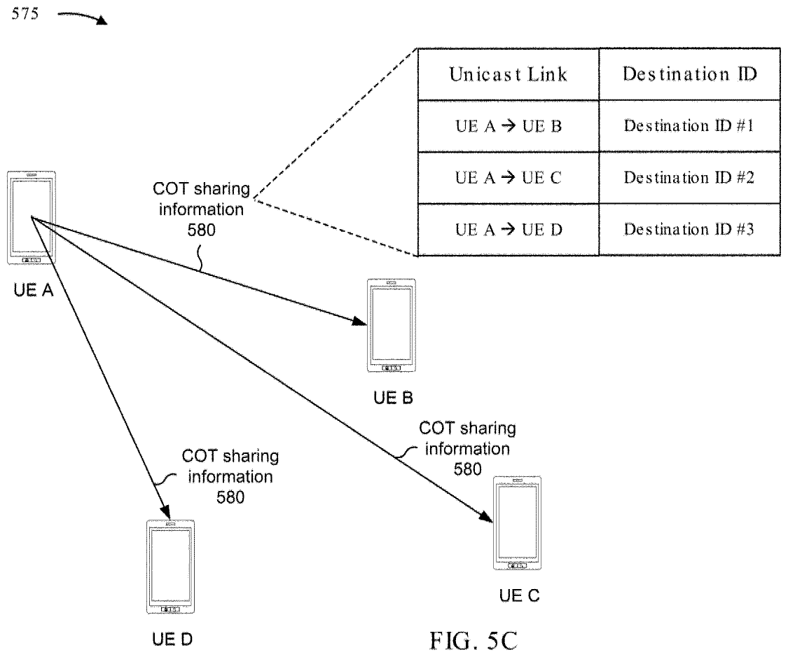

FIGS. 5A-5C are diagrams illustrating examples sidelink communications, in accordance with the present disclosure.

FIG. 5A is a diagram illustrating an example 500 of sidelink communications and access link communications, in accordance with the present disclosure. As shown in FIG. 5A, a first UE 505-1 may communicate with a second UE 505-2 (and one or more other UEs 505) via one or more sidelink channels 510. The UEs 505-1 and 505-2 may communicate using the one or more sidelink channels 510 for peer-to-peer (P2P) communications, D2D communications, vehicle-to-everything (V2X) communications (e.g., which may include vehicle-to-vehicle (V2V) communications, vehicle-to-infrastructure (V2I) communications, and/or vehicle-to-pedestrian (V2P) communications) and/or mesh networking. In some aspects, the UEs 505 (e.g., UE 505-1 and/or UE 505-2) may correspond to one or more other UEs described elsewhere herein, such as UE 120. In some aspects, the one or more sidelink channels 510 may use a PC5 interface and/or may operate in a high frequency band (e.g., the 5.9 GHZ band). Additionally, or alternatively, the UEs 505 may synchronize timing of transmission time intervals (TTIs) (e.g., frames, subframes, slots, or symbols) using global navigation satellite system (GNSS) timing.

A sidelink communication can be a communication performed (e.g., transmitted and/or received) in a unicast mode, a groupcast mode, or a broadcast mode. For unicast communication, a sidelink transmitting UE may transmit a sidelink transmission including data to a single sidelink receiving UE. For broadcast communication, a sidelink transmitting UE may transmit a sidelink transmission to a group of sidelink receiving UEs (e.g., 2, 3, 4, 5, 6 or more) in a neighborhood of the sidelink transmitting UE and may not request for an ACK/NACK feedback for the sidelink transmission. A groupcast sidelink communication can be connection-based or connectionless. A connection-based groupcast sidelink communication is destined to a specific group of UEs, for example, each belongs to a group identified by a group ID, and known to the sidelink transmitting to the UE. For a connectionless groupcast sidelink communication, the group of UEs that can receive the groupcast transmission may be unknown to the sidelink transmitting UE.

As further shown in FIG. 5A, the one or more sidelink channels 510 may include a PSCCH 515, a PSSCH 520, and/or a PSFCH 525. The PSCCH 515 may be used to communicate control information, similar to a PDCCH and/or a PUCCH used for cellular communications with a network node 550 via an access link or an access channel. The PSSCH 520 may be used to communicate data, similar to a PDSCH and/or a physical uplink shared channel (PUSCH) used for cellular communications with a network node 550 via an access link or an access channel. For example, the PSCCH 515 may carry sidelink control information (SCI) 530, which may indicate various control information used for sidelink communications, such as one or more resources (e.g., time resources, frequency resources, and/or spatial resources) where a transport block (TB) 535 may be carried on the PSSCH 520. The TB 535 may include data. The PSFCH 525 may be used to communicate sidelink feedback 540, such as HARQ feedback (e.g., acknowledgement or negative acknowledgement (ACK/NACK) information), transmit power control (TPC), and/or a scheduling request (SR).

HARQ feedback provides a mechanism for indicating, to a transmitter of a communication, whether the communication was successfully received or not. For example, the transmitter may transmit scheduling information for the communication. A receiver of the scheduling information may monitor resources indicated by the scheduling information in order to receive the communication. If the receiver successfully receives the communication, the receiver may transmit an acknowledgment (ACK) in HARQ feedback. If the receiver fails to receive the communication, the receiver may transmit a negative ACK (NACK) in HARQ feedback. Thus, based at least in part on the HARQ feedback, the transmitter can determine whether the communication should be retransmitted. HARQ feedback is often implemented using a single bit, where a first value of the bit indicates an ACK and a second value of the bit indicates a NACK. Such a bit may be referred to as a HARQ-ACK bit. HARQ-ACK feedback may be conveyed in a HARQ codebook, which may include one or more bits indicating ACKs or NACKs corresponding to one or more communications and may be referred to as HARQ feedback information (or, in the case of sidelink communications, “sidelink HARQ feedback information”).

A HARQ-ACK bit may be referred to as an ACK/NACK and/or a HARQ-ACK and may be associated with a HARQ process. The HARQ process refers to the determination of whether to report an ACK or NACK associated with a transmission, a time resource associated with the transmission (e.g., a symbol or a slot), and/or a frequency resource associated with the transmission (e.g., an RB, a subchannel, a channel, a bandwidth, and/or a bandwidth part). Accordingly, an ACK/NACK may be interchangeably referred to as being associated with a transmission, a time resource, a frequency resource, and/or a HARQ process.

Although shown on the PSCCH 515, in some aspects, the SCI 530 may include multiple communications in different stages, such as a first stage SCI (SCI-1) and a second stage SCI (SCI-2). The SCI-1 may be transmitted on the PSCCH 515.

The SCI-2 may be transmitted on the PSSCH 520. The SCI-1 may include, for example, an indication of one or more resources (e.g., time resources, frequency resources, and/or spatial resources) on the PSSCH 520, information for decoding sidelink communications on the PSSCH, a QoS priority value, a resource reservation period, a PSSCH DMRS pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 520, such as a HARQ process ID, a new data indicator (NDI), a source identifier, a destination identifier, and/or a channel state information (CSI) report trigger.

In some aspects, the one or more sidelink channels 510 may use resource pools. Resource pools may be defined for sidelink transmission and sidelink reception. A resource pool may include one or more sub-channels in the frequency domain and one or more slots in the time domain. For example, the minimum resource allocation in the frequency domain may be a sub-channel, and the minimum resource allocation in the time domain may be a slot. In some aspects, one or more slots of a resource pool may be unavailable for sidelink communications. For example, a scheduling assignment (e.g., included in SCI 530) may be transmitted in sub-channels using specific RBs across time. In some aspects, data transmissions (e.g., on the PSSCH 520) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, the UE 505-1 may operate using a sidelink transmission mode (e.g., Mode 1) where resource selection and/or scheduling is performed by the network node 550 (e.g., a base station, a CU, or a DU). For example, the UE 505-1 may receive a grant (e.g., in DCI or in an RRC message, such as for configured grants) from the network node 550 (e.g., directly or via one or more network nodes) for sidelink channel access and/or scheduling. In some aspects, a UE 505-1 may operate using a transmission mode (e.g., Mode 2) where resource selection and/or scheduling is performed by the UE 505-1 (e.g., rather than the network node 550). In some aspects, the UE 505-1 may perform resource selection and/or scheduling by sensing channel availability for transmissions. For example, the UE 505-1 may measure an received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 505-1 may perform resource selection and/or scheduling using SCI 530 received in the PSCCH 515, which may indicate occupied resources and/or channel parameters. Additionally, or alternatively, the UE 505-1 may perform resource selection and/or scheduling by determining a channel busy ratio (CBR) associated with various sidelink channels, which may be used for rate control (e.g., by indicating a maximum number of resource blocks that the UE 505-1 can use for a particular set of subframes).

In the transmission mode where resource selection and/or scheduling is performed by the UE 505-1, the UE 505-1 may generate sidelink grants, and may transmit the grants in SCI 530. A sidelink grant may indicate, for example, one or more parameters (e.g., transmission parameters) to be used for an upcoming sidelink transmission, such as one or more resource blocks to be used for the upcoming sidelink transmission on the PSSCH 520 (e.g., for TBs 535), one or more subframes to be used for the upcoming sidelink transmission, and/or an MCS to be used for the upcoming sidelink transmission. In some aspects, the UE 505-4 may generate a sidelink grant that indicates one or more parameters for semi-persistent scheduling (SPS), such as a periodicity of a sidelink transmission. Additionally, or alternatively, the UE 505-1 may generate a sidelink grant for event-driven scheduling, such as for an on-demand sidelink message.

As shown, the network node 550 may communicate with the UE 505-1 and/or the UE 505-2 (e.g., directly or via one or more network nodes), such as via an access link 555. A direct link between the UEs 550-1 and 550-2 (e.g., via a PC5 interface) may be referred to as a sidelink, and a direct link between a network node 550 and a UE 550-1 or 550-2 (e.g., via a Uu interface) may be referred to as an access link. Sidelink communications may be transmitted via the sidelink, and access link communications may be transmitted via the access link. An access link communication may be either a downlink communication (from the network node 550 to the UE 550-1 or 550-2) or an uplink communication (from a UE 550-1 or 550-2 to the network node 550).

Additionally, or alternatively, the UE 505-1 and/or 505-2 can perform resource selection and/or scheduling using SCI 530 received in the PSCCH 515, which can indicate occupied resources and/or channel parameters. Additionally, or alternatively, the UE 505-1 and/or 505-2 can perform resource selection and/or scheduling by determining a CBR associated with various sidelink channels, which can be used for rate control (e.g., by indicating a maximum number of resource blocks that the UE 505-1 and/or 505-2 can use for a particular set of subframes).

In the second transmission mode, the UE 505-1 and/or 505-2 can generate sidelink grants, and can transmit the grants in SCI 530. A sidelink grant can indicate, for example, one or more parameters (e.g., transmission parameters) to be used for an upcoming sidelink transmission, such as one or more resource blocks to be used for the upcoming sidelink transmission on the PSSCH 520 (e.g., for TBs 535), and/or one or more subframes to be used for the upcoming sidelink transmission. In some aspects, a UE 505-1 and/or 505-2 can generate a sidelink grant that indicates one or more parameters for SPS, such as a periodicity of a sidelink transmission. Additionally, or alternatively, the UE 505-1 and/or 505-2 can generate a sidelink grant for event-driven scheduling, such as for an on-demand sidelink message.

Some aspects described herein relate to an unlicensed radio frequency spectrum band, which may be used for communications in a wireless network, such as wireless network 100. In some aspects, the unlicensed radio frequency spectrum band can be used by BSs 110 and UEs 120 of a cellular network for cellular communications (e.g., NR communications), and/or by Wi-Fi access points and Wi-Fi stations of a Wi-Fi network for Wi-Fi communications, among other examples. The unlicensed radio frequency spectrum band can be used in the cellular network in combination with, or independent from, a licensed radio frequency spectrum band. In some examples, the unlicensed radio frequency spectrum band can be a radio frequency spectrum band for which a device may need to contend for access because the radio frequency spectrum band is available, at least in part, for unlicensed use, such as Wi-Fi use.

Prior to gaining access to, and communicating over, an unlicensed sidelink radio frequency spectrum band, a UE can perform a LBT procedure to contend for access to the unlicensed radio frequency spectrum band. An LBT procedure, sometimes referred to as a clear channel assessment (CCA) procedure, can include performing a CCA to determine whether a channel of the unlicensed sidelink radio frequency spectrum band is available. When it is determined that the channel of the unlicensed sidelink radio frequency spectrum band is not available (e.g., because another apparatus is already using the channel of the unlicensed sidelink radio frequency spectrum band), a CCA procedure can be performed for the channel again at a later time. In environments in which a UE can be starved of access to a channel of an unlicensed sidelink radio frequency spectrum band due to Wi-Fi activity, an extended CCA procedure can be employed to increase the likelihood that the UE will successfully contend for access to the channel of the unlicensed sidelink radio frequency spectrum band. An extended CCA procedure involves the performance of a random number of CCA procedures (from 1 to q), in accordance with an extended CCA counter.

Regardless of whether a single CCA procedure is performed or multiple CCA procedures are performed, each CCA procedure may include detecting or sensing an energy level on the channel of the unlicensed sidelink radio frequency spectrum band and determining whether the energy level is below a threshold. When the energy level satisfies (e.g., does not equal or exceed) the threshold, the CCA procedure is deemed to be successful and the transmitting device may gain access to the unlicensed channel for a duration that may be referred to as a COT during which the transmitting device can perform transmissions without performing additional LBT operations. When the energy level does not satisfy the threshold, the CCA procedure is unsuccessful and contention to access the unlicensed channel may be deemed unsuccessful.

When a CCA procedure or extended CCA procedure is successful, a transmission may be made over the channel of the unlicensed sidelink radio frequency spectrum band. When a packet error is encountered (e.g., due to a collision of transmissions made by two or more transmitting apparatuses or due to poor channel conditions), a HARQ-based retransmission can be performed. In some examples, the retransmission can be modified from the original transmission using rate adaptation (e.g., based at least in part on a CQI reported by a UE).

An LBT category can define a channel sensing duration during which a UE contending for access to a channel performs a CCA procedure. The channel sensing duration can indicate a length of time during which the UE detects or senses an energy level on the channel to determine whether the energy level is less than (or equal to) a threshold. If the energy level is less than (or equal to) the threshold, then the LBT/CCA procedure is successful, and the UE transmits a communication. If the energy level is greater than (or equal to) the threshold, then the CCA procedure is unsuccessful and the UE can wait for a period of time (e.g., a backoff duration) before performing the CCA procedure again.

Example LBT categories include category one (Cat 1) LBT, category two (Cat 2) LBT, category three (Cat 3) LBT, and category four (Cat 4) LBT. In Cat 1 LBT, also referred to as no LBT, an LBT procedure is not performed prior to transmission of a communication on the channel. In Cat 2 LBT, the channel sensing duration is fixed (e.g., without random back-off). For example, a 16 microsecond channel sensing duration is used for 16 microsecond Cat 2 LBT, and a 25 microsecond channel sensing duration is used for 25 microsecond Cat 2 LBT. In Cat 3 LBT, the channel sensing duration is fixed (e.g., a contention window has a fixed size), and random back-off is used. In Cat 4 LBT, the channel sensing duration is variable (e.g., a contention window has a variable size), and random back-off is used.

In Cat 4 LBT, the channel sensing duration may be variable depending on whether the device contending for access to the channel senses interference (e.g., an energy level greater than or equal to a threshold). Using a Cat 4 LBT procedure, the device may select a minimum channel sensing duration, which may be defined by a channel access priority class (CAPC) associated with the Cat 4 LBT procedure being used by the device. For example, four different CAPCs may be associated with Cat 4 LBT, with the lowest CAPC value (e.g., CAPC 0) being associated with the highest priority for Cat 4 LBT (e.g., the shortest contention window size and shortest back-off duration), and the highest CAPC value (e.g., CAPC 3) being associated with the lowest priority for Cat 4 LBT (e.g., the longest contention window size and longest back-off duration). Generally, a higher CAPC value (e.g., a higher CAPC index) is associated with a lower priority. In Cat 4 LBT, if the device detects interference in the minimum channel sensing duration for a CCA procedure as defined by a CAPC for the Cat 4 LBT procedure, then the device may increase the channel sensing duration for the next CCA procedure.

Accordingly, although a wireless network can be configured to use unlicensed spectrum to achieve faster data rates, provide a more responsive user experience, and/or offload traffic from a licensed spectrum, among other examples, the need to ensure fair coexistence with incumbent systems (e.g., wireless local area network (WLAN) devices) may hamper efficient usage of the unlicensed spectrum. For example, even when there is no interference, the LBT procedure used to ensure that no other devices are already using the channel introduces a delay before transmissions can start, which may degrade user experience, result in unacceptable performance for latency-sensitive or delay-sensitive applications, and/or the like. Furthermore, these problems may be exacerbated when the initial CCA procedure is unsuccessful, as the transmitting device can transmit on the channel only after performing an additional quantity of CCA procedures and determining that the channel has become clear and remained clear for a random wait period. Furthermore, in some cases, the COT obtained by a transmitting device may have a duration that is longer than necessary for the transmitting device to perform the desired transmissions, which may lead to inefficient usage of the unlicensed channel.

Accordingly, in some cases, a wireless network may enable a COT obtained by a transmitting device to be shared with other nodes in order to improve access and efficiency for an unlicensed channel. Sharing a COT includes sharing shareable resources of a COT. For example, in downlink-to-uplink COT sharing over an access link, a network node 550 may acquire a COT with an extended CCA (eCCA), and the COT may be shared with one or more UEs (e.g., UE 505-1 and/or UE 505-2) that can then transmit uplink signals within the COT acquired by the network node 550. In this case, a UE attempting to initiate an uplink transmission within the COT shared with the network node 550 can perform an uplink transmission without having to perform an LBT procedure, or the UE may perform the uplink transmission after performing a single-shot CCA with a shorter LBT procedure (e.g., a category 2 LBT procedure when the downlink-to-uplink gap duration is between 16 and 25 μs, a category 1 LBT procedure when a downlink-to-uplink gap duration is less than or equal to 16 μs, and/or the like).

Additionally, or alternatively, a wireless network may support uplink-to-downlink COT sharing over an access link. In this case, a UE-initiated COT (e.g., for a configured grant PUSCH or a scheduled uplink transmission) can be shared with the network node 550. In this way, the network node 550 may be allowed to transmit control and/or broadcast signals and/or channels for any UE served by the network node 550, provided that the transmission contains a downlink signal, channel, and/or other transmission (e.g., a PDSCH, PDCCH, reference signal, and/or the like) intended to be received by the UE that initiated the channel occupancy.

Additionally, or alternatively, a wireless network may support UE-to-UE COT sharing over a sidelink.

FIG. 5B is a diagram illustrating an example 560 associated with UE-to-UE COT sharing over a sidelink, in accordance with the present disclosure. For example, as shown in FIG. 5B, and by reference number 565, a COT acquired by an initiating UE (e.g., UE 505-1) may be shared in a frequency division multiplexing (FDM) mode by dividing the COT into multiple interlaces (e.g., time periods during which one or more UEs may perform transmit operations). For example, as shown in FIG. 5B, the initiating UE may use one or more sidelink resources (e.g., time and frequency resources) to transmit in a first interlace after the COT has been acquired, and a responding UE (e.g., UE 505-2) may use sidelink frequency resources that are non-overlapping with sidelink frequency resources used by the initiating UE to perform transmit operations in subsequent interlaces. Accordingly, as shown in FIG. 5B, FDM or interlace-based COT sharing may introduce short transmission gaps between interlaces to allow other UEs to perform transmit operations in subsequent interlaces during a shared COT, and sidelink control information transmitted by the initiating UE may carry information to support the interlace-based COT sharing.

As used herein, the term “initiating UE” can refer to a UE that initiates (which may be interchangeably referred to as “acquires”) a COT in a shared radio frequency band (e.g., in a shared spectrum or an unlicensed spectrum) for sidelink communication. As used herein, the term “responding UE” can refer to a UE that responds to a sidelink transmission transmitted by any initiating UE. A sidelink UE may operate as an initiating UE at one time and operate as a responding UE at another time. The initiating UE may be referred to herein as a transmitting UE, a COT initiating UE, and/or a COT initiator UE, and the responding UE(s) may be referred to as receiving UE(s). An eligible COT sharing UE is a UE that is eligible to share a COT acquired by an initiating UE. A UE may be eligible to share a COT as a result of being configured for COT sharing, as a result of having an eligible CAPC, and/or as a result of being a member of a COT sharing UE group associated with an initiating UE.

Additionally, or alternatively, as shown by reference number 570, UE-to-UE COT sharing may be enabled in a time division multiplexing (TDM) mode. In this case, the total COT may be divided into an initial time period during which the initiating UE may perform transmissions, which may include one or more sidelink control information transmissions that indicate when the initial transmission will end, a remaining duration of the COT that is available for sharing, or the like. As described above, UE-to-UE COT sharing may enable better access to unlicensed spectrum, more efficient usage of unlicensed spectrum, or the like by enabling multiple UEs (e.g., a responding sidelink UE 1 and a responding sidelink UE 2) to perform transmissions during a COT that is obtained by an initiating UE (e.g., a UE that successfully performed an LBT procedure to acquire access to an unlicensed channel). In some examples, a receiving UE may be permitted to share a COT of a transmitting UE if the receiving UE is a target receiver of the transmitting UE's COT transmission (that is, a transmission for which the transmitting UE acquired the COT or a transmission by the transmitting UE in the transmitting UE's COT).

FIG. 5C is a diagram illustrating another example 575 associated with UE-to-UE COT sharing over a sidelink, in accordance with the present disclosure.

Example 575 shows an initiating UE (“UE A”) that may communicate with a UE B, a UE C, and a UE D via a sidelink. To facilitate sharing a COT with one or more of the UE B, the UE C, and the UE D, as shown by reference number 580, the UE A may transmit COT sharing information. The COT sharing information may indicate a CAPC associated with the COT, a remaining COT duration (e.g., a number of slots remaining or a number of milliseconds remaining), a layer 1 ID (e.g., a sidelink layer 1 source ID or a sidelink layer 1 destination ID), and/or one or more RB sets of the COT, among other examples. Each UE also may include a sidelink layer 2 source ID and a sidelink layer 2 destination ID associated with sidelink communications.

In some cases, to facilitate more efficient sidelink communications in cases in with shareable resources of a COT are shared between UEs, one or more COT sharing IDs may be introduced. The COT sharing IDs are additional IDs to the sidelink layer 1 IDs and/or sidelink layer 2 IDs. The one or more additional IDs can indicate eligible COT sharing UEs. For example, as shown in FIG. 5C, the COT sharing information may include COT sharing IDs identifying the UE A as the source UE and respective receiving UEs (UE B, UE C, and UE D) as eligible COT sharing UEs. For example, as shown, the COT sharing information may include, for a unicast link between the UE A and the UE B, a destination ID #1 associated with the UE B. The COT sharing IDs may include, for a unicast link between the UE A and the UE C, a destination ID #2 associated with the UE C. Similarly, the COT sharing information may include, for a unicast link between the UE A and the UE D, a destination ID #3 associated with the UE D. Thus, the COT sharing IDs may include only the destination ID #s 1, 2, and 3.

Since the COT sharing information does not include a source ID and the sidelink source ID (e.g., unicast source ID) of the UE A can be different across different unicast sessions or cast types, it can be possible that a responding UE (e.g., the UE B, the UE C, or the UE D) may not use the sidelink source ID as a destination ID for transmitting to the UE A. For example, when a receiving UE (e.g., the UE C) is not a target receiver of the UE A's data transmission, the UE C can be unable to identify the UE A as the COT initiator, resulting in failure of the UE C to identify the UE A as a receiver of a transmission from the UE C within the shared COT, resulting in a transmission that is violative of sidelink COT sharing, leading to a failure to successfully share the COT, thereby negatively impacting network performance.

Some aspects of the techniques and apparatuses described herein provide COT sharing IDs for facilitating identification of an initiator UE as well as eligible COT sharing UEs. For example, in some aspects, the UE A may establish (e.g., acquire) a COT via an LBT procedure. The UE A may transmit COT sharing information indicating shareable resources of the COT. The COT sharing information also may indicate a COT sharing ID. The COT sharing ID may include a source ID associated with the UE A and a destination ID associated with a receiving UE (e.g., the UE B, the UE C, and/or the UE D). The destination ID may indicate the receiving UE as an eligible COT sharing UE. In some aspects, the COT sharing ID may include a unicast mode source ID and a unicast mode destination ID, which may facilitate unicast communications within the shared COT. The unicast mode source ID and the unicast mode destination ID may include a pair of layer 1 IDs or a pair of layer 2 IDs. In some aspects, truncated source IDs and/or destination IDs may be used to reduce the payload size of the COT sharing ID.

In some aspects, the COT initiator UE may configure a table, via PC-5 RRC signaling, that includes a table ID (which may relate to an application layer ID of an application layer associated with the sidelink communications) and a mapping between a set of table indices and ID pairs. For example, the mapping may map a table index to an ID pair that includes a unicast mode source ID and a unicast mode destination ID. The COT sharing ID may indicate the table ID and one or more table indices. In this way, a receiving UE may identify whether the receiving UE is an eligible COT sharing UE via the table. The receiving UE also may identify the COT initiator UE via the table.

In some aspects, the COT sharing ID may include a common destination ID (a “group destination ID”) to indicate a group of eligible COT sharing UEs, rather than indicating a distinct COT sharing destination ID associated with each eligible COT sharing UE, thereby indicating eligible COT sharing UEs without increasing the COT sharing ID payload as much as distinct COT sharing destination IDs would. The group of eligible COT sharing UEs may include a group of UEs configured for groupcast communications with the COT initiator UE. In some aspects, for example, the COT sharing ID may include a group COT initiator ID associated with the COT initiator UE and a group destination ID associated with the group of eligible COT sharing UEs. In some aspects, the group destination ID may be a groupcast mode destination ID while, in some other aspects, the group destination ID may be unrelated to groupcast mode communications. In some aspects, the COT sharing ID may include one or more unicast mode IDs (e.g., one or more unicast source IDs or unicast destination IDs) in addition to one or more group destination IDs.

In some cases, because potentially eligible COT sharing UEs may not be part of a groupcast group of the COT initiator UE, the COT initiator UE may configure one or more groups for COT sharing. For example, the COT initiator UE may transmit PC-5 RRC configuration information that configures the one or more groups of UEs. The UEs belonging to a configured group may be eligible for sharing a COT with the COT initiator UE. The COT sharing ID may include a group destination ID associated with the group of UEs and a global COT initiator ID. Each group may include one or more UEs and may be mutually exclusive with another group or may at least partially overlap with another group. In some aspects, the COT sharing ID may include the group destination ID and a bitmap that indicates the eligible COT sharing UEs within the group.

By including a COT sharing source ID as well as the COT sharing destination ID, a receiving UE may identify a transmitting UE as a COT initiator of a shared COT. Identification of the COT initiator UE by a receiving UE may facilitate communication from the receiving UE to the COT initiator UE within the shared COT, which may result in more efficient transmissions within the shared COT, a lower likelihood of missed transmissions within the shared COT, and/or a lower likelihood of unsuccessful attempts to share the COT, thereby positively impacting network performance.

As indicated above, FIGS. 5A-5C are provided as examples. Other examples may differ from what is described with regard to FIGS. 5A-5C.

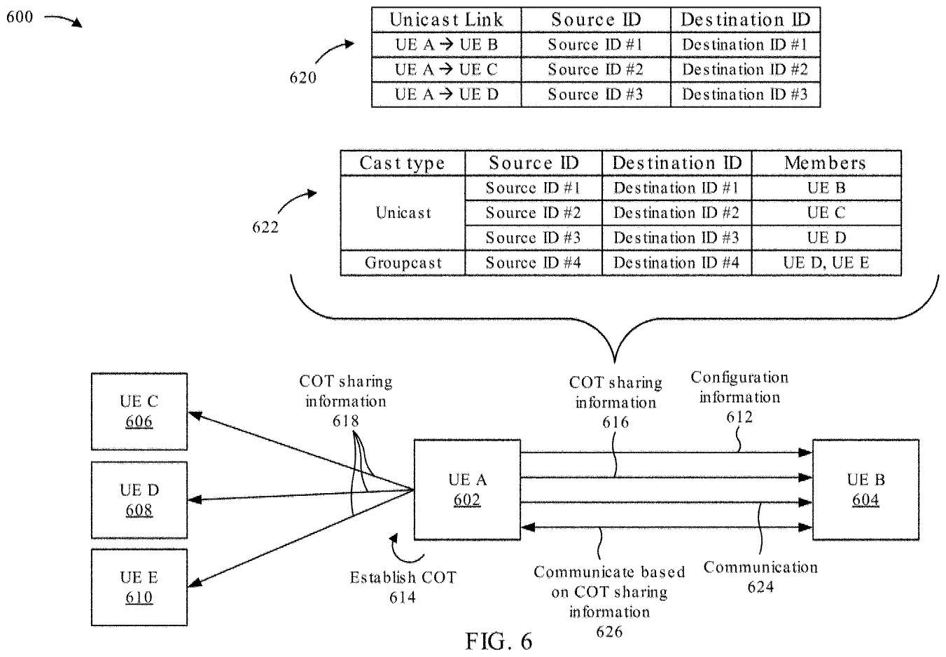

FIG. 6 is a diagram illustrating an example 600 associated with COT sharing IDs, in accordance with the present disclosure. As shown in FIG. 6, a UE A 602 may communicate with a UE B 604, a UE C 606, a UE D 608, and a UE E 610. The UEs 602, 604, 606, 608, and 610 may communicate via a sidelink. In some aspects, the UE A 602, the UE B 604, the UE C 606, the UE D 608, and/or the UE E 610 may be, be similar to, include, or be included in, the UE 505-1 depicted in FIG. 3, the UE 505-2 depicted in FIG. 3, and/or the UE 120 depicted in FIGS. 1-3.

As shown by reference number 612, the UE A 602 may transmit, and the UE B 604 may receive, configuration information. The UE A 602 may transmit the configuration information by transmitting a PC-5 RRC communication that includes the configuration information. In some aspects, the configuration information may include an ID mapping table, which is described in more detail below. In some aspects, the configuration information may configure a group of COT sharing eligible UEs. The group of COT sharing eligible UEs may be configured by the UE A 602 and may include UEs eligible to share a COT acquired by the UE A 602. A COT sharing eligible UE may be eligible to share a COT as a result of being configured for COT sharing, as a result of having an eligible CAPC, and/or as a result of being configured for an eligible cast type (e.g., unicast, broadcast, and/or groupcast).

As shown by reference number 614, the UE A 602 may establish a COT. For example, the UE A 602 may establish a COT by acquiring a COT using an LBT procedure, as described herein. The COT may include a shareable set of resources (e.g., time resources and frequency resources). Accordingly, the UE A 602 may be a COT initiator UE. In some aspects, the UE A 602 may successfully perform an LBT procedure to acquire the COT. For example, prior to gaining access to, and transmitting over, the unlicensed channel, the UE A 602 may perform the LBT procedure to contend for access to the unlicensed channel. In some aspects, the LBT procedure may include a CCA procedure that the transmitting UE performs to determine whether the unlicensed channel is available (e.g., unoccupied by other transmitters). In some aspects, the UE A 602 may detect an energy level on the unlicensed channel, and the CCA procedure may be determined to be successful if the energy level on the unlicensed channel satisfies (e.g., is less than or equal to) a threshold. In such cases, the UE A 602 may gain access to the unlicensed channel to acquire the COT during which the transmitting UE (e.g., the UE A 602) can perform transmissions without performing additional LBT operations.

In cases where the energy level detected on the unlicensed channel fails to satisfy a threshold (e.g., is greater than or equal to the threshold), the CCA procedure may be determined to be unsuccessful, and the UE A 602 may perform the CCA procedure again and acquire the COT at a later time. Additionally, or alternatively, the UE A 602 may acquire the COT by performing another type of channel access procedure. For example, the UE A 602 may acquire the COT by performing an eCCA procedure.

As shown by reference number 616, the UE A 602 may transmit, and the UE B 604 may receive, COT sharing information. As shown by reference number 618, the UE A 602 may transmit, and the UE C 606, the UE D 608, and/or the UE E 610 may receive, the COT sharing information. In some aspects, the UE C 606, the UE D 608, and/or the UE E 610 may receive the same transmission of COT sharing information received by the UE B 604. In some aspects, the UE A 602 may transmit the COT sharing information using multiple, distinct transmissions to each of the UE B 604, the UE C 606, the UE D 608, and/or the UE E 610.

The COT sharing information may indicate a set of shareable resources (e.g., time resources and/or frequency resources) of the COT. The COT sharing information also may indicate a CAPC associated with the COT, a remaining COT duration (e.g., a number of slots remaining or a number of milliseconds remaining), a layer 1 ID (e.g., a sidelink layer 1 source ID or a sidelink layer 1 destination ID), and/or one or more RB sets of the COT, among other examples. In some aspects, the COT sharing information may include a COT sharing ID.

The COT sharing ID may indicate at least one COT sharing source ID associated with the UE A 602 and at least one COT sharing destination ID associated with one or more of the UE B 604, the UE C 606, the UE D 608, and/or the UE E 610. The COT sharing ID may indicate the at least one COT sharing source ID and/or the at least one COT sharing destination ID by explicitly or implicitly indicating the at least one COT sharing source ID and/or the at least one COT sharing destination ID.

In some aspects, for example, the COT sharing ID may indicate a unicast mode source ID associated with the UE A 602 and a unicast mode destination ID associated with the UE B 604. The unicast mode destination ID may identify the UE B 604 as eligible for sharing the set of shareable resources. As shown by the table 620 representing the IDs indicated by the COT sharing ID, the COT sharing ID may indicate a first unicast mode source ID (“source ID #1”) and a first unicast mode destination ID (“destination ID #1”) for a unicast link between the UE A 602 and the UE B 604, a second unicast mode source ID (“source ID #2”) and a second unicast mode destination ID (“destination ID #2”) for a unicast link between the UE A 602 and the UE C 606, and a third unicast mode source ID (“source ID #3”) and a third unicast mode destination ID (“destination ID #3”) for a unicast link between the UE A 602 and the UE D 608.

In some aspects, the COT sharing ID may indicate layer 1 and/or layer 2 ID pairs. For example, the first unicast mode source ID may include a first layer 1 ID and the first unicast mode destination ID may include a second layer 1 ID. The second unicast mode source ID may include a third layer 1 ID and the second unicast mode destination ID may include a fourth layer 1 ID. The third unicast mode source ID may include a fifth layer 1 ID and the third unicast mode destination ID may include a sixth layer 1 ID. In some aspects, the first unicast mode source ID may include a first layer 2ID and the first unicast mode destination ID may include a second layer 2 ID. The second unicast mode source ID may include a third layer 2 ID and the second unicast mode destination ID may include a fourth layer 2 ID. The third unicast mode source ID may include a fifth layer 2 ID and the third unicast mode destination ID may include a sixth layer 2 ID. In some aspects, the COT sharing ID may include any combination of layer 1 and layer 2 IDs.

In some aspects, to reduce payload of the COT sharing ID, the COT sharing ID may include a truncated source ID associated with the first unicast mode source ID and/or a truncated destination ID associated with the first unicast mode destination ID. For example, in some aspects, the COT sharing ID may include one or more of the least significant bits (LSBs) of a layer 1 destination ID and one or more of the LSBs of a layer 1 source ID.

In some aspects, to save COT sharing ID payload, the COT sharing ID may include a table ID associated with a configured ID mapping table and a table index. The table index may be associated with a mapping, indicated in the ID mapping table, between the table index and an ID pair. The ID pair may include, for example, a unicast mode source ID and a unicast mode destination ID. In some aspects, the table ID may be associated with an application layer ID. For example, the table ID may include a portion of the application layer ID, may be mapped to the application layer ID, and/or may be derived from (e.g., calculated as a function of) the application layer ID, among other examples. In some aspects, one or more of the UEs 604, 606, 608, and 610 may identify an eligibility, of the respective UE, for COT sharing via a table index included in the COT sharing ID. In some aspects, one or more of the UEs 604, 606, 608, and 610 may identify the COT initiator UE (e.g., the UE A 602) via the table ID.

In some aspects, the COT sharing ID may indicate a group destination ID. For example, the group destination ID may be associated with groupcast mode communications. For example, the group destination ID may be associated with a group of UEs that are eligible COT sharing UEs. In some aspects, the COT sharing ID may include an ID pair (e.g., a group COT initiator ID and a group destination ID). In aspects in which the destination ID is an ID which is used in a first groupcast option, the COT sharing ID may include an ID pair. In aspects in which the destination ID is an ID which is used in a second groupcast option, the COT sharing ID may include only the group destination ID.

For example, in the first groupcast option, a default destination ID may be used as the group destination ID. The default destination ID may be shared by the group of UEs. Since a receiving UE (e.g., the UE B 604) may not identify the COT initiator based on a groupcast communication, the COT sharing ID may include a global COT initiator ID associated with the UE A 602. In some aspects, the global COT initiator ID may be associated with an application layer ID. For example, the global COT initiator ID may include a portion of the application layer ID, may be mapped to the application layer ID, and/or may be derived from (e.g., calculated as a function of) the application layer ID, among other examples. In the second groupcast option, the group destination ID may be derived from a group ID associated with the group of COT sharing eligible UEs. In some aspects, the group ID may be configured by an application layer. In the second groupcast option, the group destination ID may be related to the UE A 602 and, accordingly, a receiving UE (e.g., the UE B 604) may identify the COT initiator UE based on the group destination ID.

In some aspects, as shown by representative table 622, the COT sharing ID may include a combination of unicast mode IDs and groupcast mode IDs. For example, a unicast mode destination ID may be included for one or more UEs that are not included in a groupcast group. In some aspects, both a unicast mode destination ID and a group destination ID may be associated with a receiving UE (e.g., the UE B 604) and indicated by the COT sharing ID.

In some aspects, the group sharing destination ID may be unassociated with a groupcast mode of communications. For example, the UE A 602 may configure one or more groups of UEs dedicated to COT sharing via PC-5 RRC signaling. Each group may have a unique corresponding group ID and may include one or more UEs (e.g., one or more of the UE B 604, the UE C 606, the UE D 608, and the UE E 610). In some aspects, configured groups may include distinct (e.g., mutually exclusive) sets of UEs and, in some other aspects, two or more groups may at least partially overlap (e.g., the two or more groups may have at least one UE in common). The COT sharing ID may include a global COT initiator ID and a group ID. The global COT initiator ID may be used by UEs of a group to identify the UE A 602 as the COT initiator UE. this configuration so that group members can identify which UE is COT initiator UE. In some aspects, the global COT initiator ID may be associated with an application layer ID. For example, the global COT initiator ID may include a portion of the application layer ID, may be mapped to the application layer ID, and/or may be derived from (e.g., calculated as a function of) the application layer ID, among other examples.

In some aspects, the COT sharing ID may include a group ID that indicates a COT sharing eligible group of UEs. The COT sharing ID also may include one or more COT sharing eligibility indications. Each COT sharing eligibility indication of the one or more COT sharing eligibility indications may be associated with a respective UE of a group. For example, each COT sharing eligibility indication may indicate whether a respective UE of a group identified by the group ID is a COT sharing eligible UE. In some aspects, the one or more COT sharing eligibility indications may be included in a bitmap.

In some aspects in which the COT sharing ID indicates a layer 1 ID pair, and since layer 1 ID pairs may not be unique in the sidelink network, the identity of the COT initiator UE may be ambiguous to a receiving UE (e.g., the UE B 604). For example, the UE B 604 may have established a set of associations with other UEs and may use layer 2 source IDs for identifying specific UEs. However, when the COT sharing ID indicates a layer 1 ID pair, the layer 1 source ID may be associated with more than one source UE. To facilitate identification, by the UE B 604, of the UE A 602 as the COT initiator UE, a layer 2 source ID associated with the UE A 602 may be used. For example, as shown by reference number 624, the UE A 602 may transmit, and the UE B 604 may receive, a communication. The UE A 602 may transmit the communication during the COT and the UE B 604 may, as part of receiving the communication, decode SCI and a MAC protocol data unit (PDU) to determine the layer 2 source ID associated with the UE A 602, thereby identifying the UE A 602 as the COT initiator UE.

As shown by reference number 626, the UE B 604 may communicate with the UE A 602 based on the COT sharing information. For example, by identifying the UE A 602 as the COT initiator UE, from the COT sharing ID contained in the COT sharing information, the UE B 604 may transmit a sidelink communication to the UE A 602 within the COT.

As indicated above, FIG. 6 is provided as an example. Other examples may differ from what is described with regard to FIG. 6.

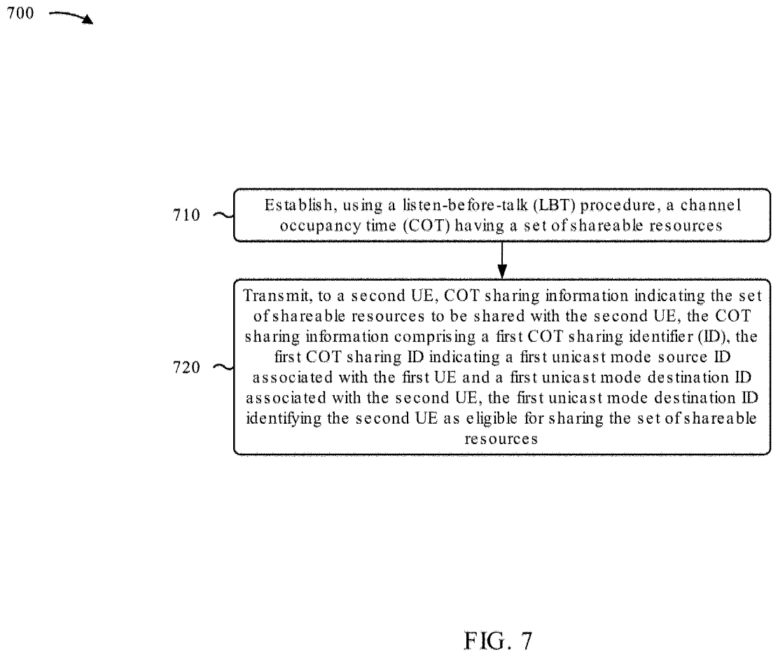

FIG. 7 shows a method 700 for wireless communications by a first UE, such as UE 120.

Method 700 begins at 710 with establishing, using an LBT procedure, a COT having a set of shareable resources.

Method 700 then proceeds to step 720 with transmitting, to a second UE, COT sharing information indicating the set of shareable resources to be shared with the second UE, the COT sharing information comprising a first COT sharing ID, the first COT sharing ID indicating a first unicast mode source ID associated with the first UE and a first unicast mode destination ID associated with the second UE, the first unicast mode destination ID identifying the second UE as eligible for sharing the set of shareable resources.

In one aspect, the first COT sharing ID comprises the first unicast mode source ID and the first unicast mode destination ID.

In one aspect, the first unicast mode source ID comprises a first layer 2 ID and the first unicast mode destination ID comprises a second layer 2 ID.

In one aspect, the first unicast mode source ID comprises a first layer 1 ID and the first unicast mode destination ID comprises a second layer 1 ID.

In one aspect, the first COT sharing ID includes at least one of a truncated source ID associated with the first unicast mode source ID or a truncated destination ID associated with the first unicast mode destination ID.

In one aspect, the first COT sharing ID comprises a table ID associated with a configured ID mapping table, wherein the table ID is associated with an application layer ID, and a table index associated with a mapping between the table index and an ID pair, the ID pair comprising the first unicast mode source ID and the first unicast mode destination ID.

In one aspect, the ID mapping table indicates the mapping.

In one aspect, method 700 further includes transmitting configuration information that comprises the ID mapping table.

In one aspect, transmitting the configuration information comprises transmitting a PC-5 radio resource control communication that comprises the configuration information.

In one aspect, the COT sharing information further comprises a second COT sharing ID, the second COT sharing ID indicating a second unicast mode source ID, different from the first unicast mode source ID, associated with the first UE, and a second unicast mode destination ID, different from the first unicast mode destination ID, associated with a third UE.

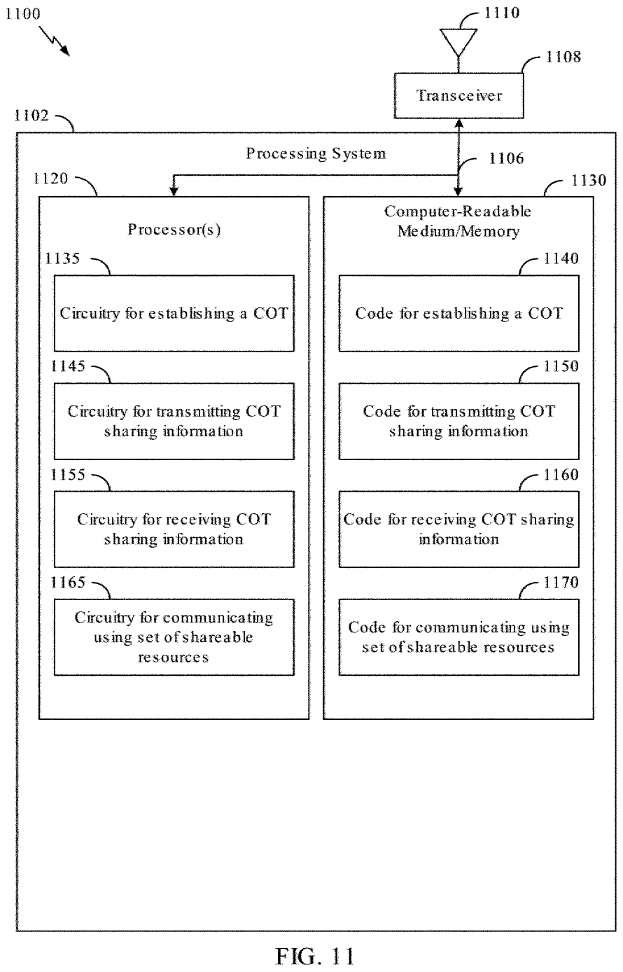

In one aspect, method 700, or any aspect related to it, may be performed by an apparatus, such as communications device 1100 of FIG. 11, which includes various components operable, configured, or adapted to perform the method 700. Communications device 1100 is described below in further detail.

Note that FIG. 7 is just one example of a method, and other methods including fewer, additional, or alternative steps are possible consistent with this disclosure.

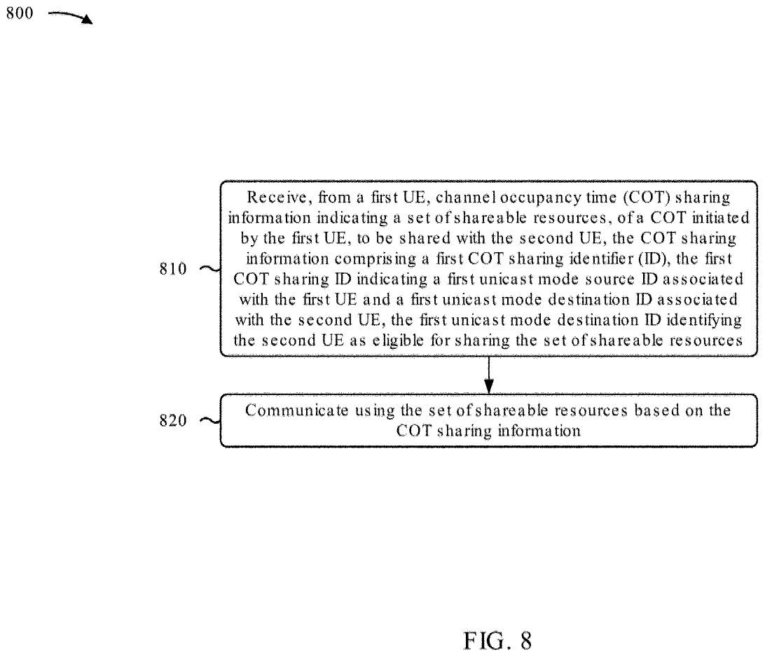

FIG. 8 shows a method 800 for wireless communications by a second UE, such as UE 120.

Method 800 begins at 810 with receiving, from a first UE, COT sharing information indicating a set of shareable resources, of a COT initiated by the first UE, to be shared with the second UE, the COT sharing information comprising a first COT sharing ID, the first COT sharing ID indicating a first unicast mode source ID associated with the first UE and a first unicast mode destination ID associated with the second UE, the first unicast mode destination ID identifying the second UE as eligible for sharing the set of shareable resources.

Method 800 then proceeds to step 820 with communicating using the set of shareable resources based on the COT sharing information.

In one aspect, the first COT sharing ID comprises the first unicast mode source ID and the first unicast mode destination ID.

In one aspect, the first unicast mode source ID comprises a first layer 2 ID and the first unicast mode destination ID comprises a second layer 2 ID.

In a third aspect, alone or in combination with one or more of the first and second aspects, the first unicast mode source ID comprises a first layer 1 ID and the first unicast mode destination ID comprises a second layer 1 ID.

In one aspect, the first unicast mode source ID comprises a layer 1 source ID, and method 800 further includes receiving, during the COT, a communication from the first UE, the communication comprising a layer 2 source ID associated with the first UE, wherein an identification of the first UE as a COT initiator of the COT is based on the layer 2 source ID.

In one aspect, the first COT sharing ID comprises at least one of a truncated source ID associated with the first unicast mode source ID or a truncated destination ID associated with the first unicast mode destination ID.

In one aspect, the first COT sharing ID comprises a table ID associated with a configured ID mapping table, wherein the table ID is associated with an application layer ID, and a table index associated with a mapping between the table index and an ID pair, the ID pair comprising the first unicast mode source ID and the first unicast mode destination ID.

In one aspect, the ID mapping table indicates the mapping.

In one aspect, the ID mapping table indicates that the first UE is a COT initiator of the COT.

In one aspect, method 800 further includes receiving configuration information that comprises the ID mapping table.

In one aspect, receiving the configuration information comprises receiving a PC-5 radio resource control communication that comprises the configuration information.

In one aspect, the COT sharing information further comprises a second COT sharing ID, the second COT sharing ID indicating a second unicast mode source ID, different from the first unicast mode source ID, associated with the first UE and a second unicast mode destination ID, different from the first unicast mode destination ID, associated with a third UE.

In one aspect, method 800, or any aspect related to it, may be performed by an apparatus, such as communications device 1100 of FIG. 11, which includes various components operable, configured, or adapted to perform the method 800. Communications device 1100 is described below in further detail.

Note that FIG. 8 is just one example of a method, and other methods including fewer, additional, or alternative steps are possible consistent with this disclosure.

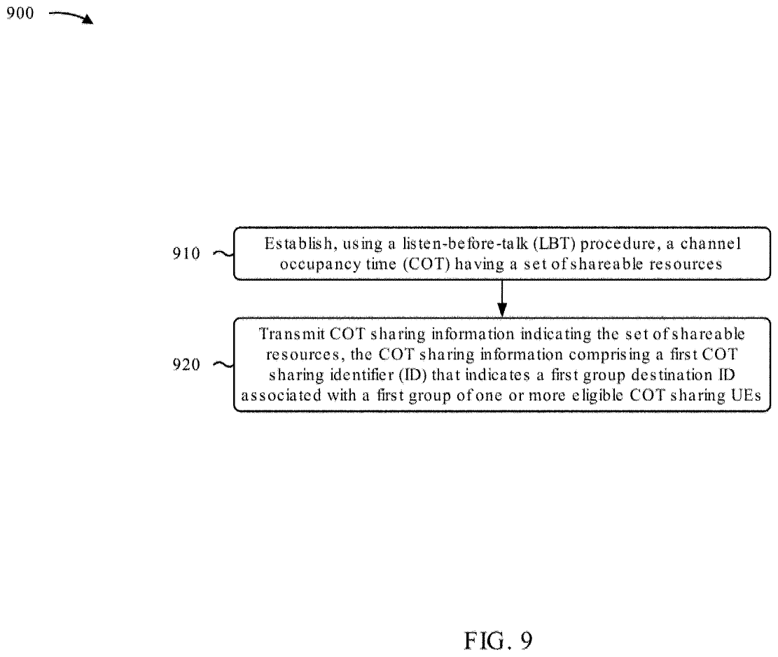

FIG. 9 shows a method 900 for wireless communications by a first UE, such as UE 120.

Method 900 begins at 910 with establishing, using an LBT procedure, a COT having a set of shareable resources.

Method 900 then proceeds to step 920 with transmitting COT sharing information indicating the set of shareable resources, the COT sharing information comprising a first COT sharing ID that indicates a first group destination ID associated with a first group of one or more eligible COT sharing UEs.

In one aspect, the first group destination ID is associated with groupcast mode communications.

In one aspect, the first COT sharing ID further comprises a COT initiator ID associated with the first UE.

In one aspect, the COT initiator ID is associated with an application layer ID.

In one aspect, the first group destination ID is associated with the first UE.

In one aspect, the COT sharing information further comprises a second COT sharing ID, the second COT sharing ID indicating at least one of a unicast mode source ID associated with the first UE or a unicast mode destination ID associated with a second UE.

In one aspect, the COT sharing information further includes a second COT sharing ID that indicates a second group destination ID associated with a second group of one or more eligible COT sharing UEs.

In one aspect, the second COT sharing ID further comprises a COT initiator ID associated with the first UE.

In one aspect, method 900 further includes transmitting configuration information that configures the first group.

In one aspect, transmitting the configuration information comprises transmitting a PC-5 radio resource control communication that includes the configuration information.

In one aspect, the first COT sharing ID comprises the group destination ID and one or more COT sharing eligibility indications, wherein each COT sharing eligibility indication of the one or more COT sharing eligibility indications is associated with a respective UE of the first group of one or more UEs.

In one aspect, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative steps are possible consistent with this disclosure.

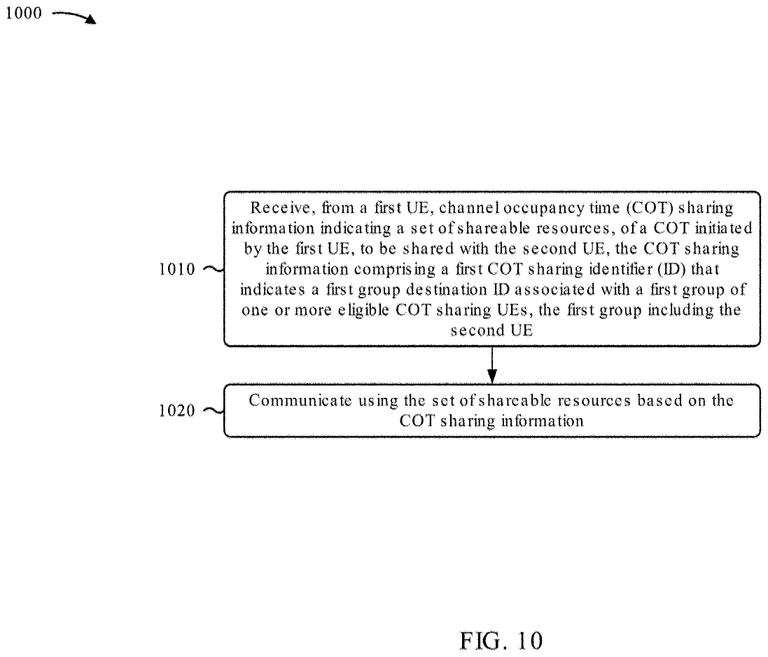

FIG. 10 shows a method 1000 for wireless communications by a second UE, such as UE 120.

Method 1000 begins at 1010 with receiving, from a first UE, COT sharing information indicating a set of shareable resources, of a COT initiated by the first UE, to be shared with the second UE, the COT sharing information comprising a first COT sharing ID that indicates a first group destination ID associated with a first group of one or more eligible COT sharing UEs, the first group including the second UE.

Method 1000 then proceeds to step 1020 with communicating using the set of shareable resources based on the COT sharing information.

In one aspect, the first group destination ID is associated with groupcast mode communications.

In one aspect, the first COT sharing ID further comprises a COT initiator ID associated with the first UE.

In one aspect, the COT initiator ID is associated with an application layer ID.

In one aspect, the first group destination ID is associated with the first UE.

In one aspect, the COT sharing information further comprises a second COT sharing ID, the second COT sharing ID indicating at least one of a unicast mode source ID associated with the first UE or a unicast mode destination ID associated with the second UE.

In one aspect, the COT sharing information further comprises a second COT sharing ID that indicates a second group destination ID associated with a second group of one or more eligible COT sharing UEs.

In one aspect, the second COT sharing ID further comprises a COT initiator ID associated with the first UE.

In one aspect, method 1000 further includes receiving configuration information that configures the first group.

In one aspect, receiving the configuration information comprises receiving a PC-5 radio resource control communication that includes the configuration information.

In one aspect, the first COT sharing ID comprises the group destination ID and one or more COT sharing eligibility indications, wherein each COT sharing eligibility indication of the one or more COT sharing eligibility indications is associated with a respective UE of the first group of one or more UEs.

In one aspect, method 1000, or any aspect related to it, may be performed by an apparatus, such as communications device 1100 of FIG. 11, which includes various components operable, configured, or adapted to perform the method 1000. Communications device 1100 is described below in further detail.

Note that FIG. 10 is just one example of a method, and other methods including fewer, additional, or alternative steps are possible consistent with this disclosure.

FIG. 11 is a diagram illustrating an example of an implementation of code and circuitry for a communications device 1100, in accordance with the present disclosure. The communications device 1100 may be a UE, or a UE may include the communications device 1100.

The communications device 1100 includes a processing system 1102 coupled to a transceiver 1108 (e.g., a transmitter and/or a receiver). The transceiver 1108 is configured to transmit and receive signals for the communications device 1100 via an antenna 1110, such as the various signals as described herein. The processing system 1102 may be configured to perform processing functions for the communications device 1100, including processing signals received and/or to be transmitted by the communications device 1100.

The processing system 1102 includes one or more processors 1120. In various aspects, the one or more processors 1120 may be representative of one or more of receive processor 258, transmit processor 264, TX MIMO processor 266, and/or controller/processor 280, as described with respect to FIG. 2. The one or more processors 1120 are coupled to a computer-readable medium/memory 1130 via a bus 1106. In various aspects, the computer-readable medium/memory 1130 may be representative of memory 282, as described with respect to FIG. 2. In certain aspects, the computer-readable medium/memory 1130 is configured to store instructions (e.g., computer-executable code, processor-executable code) that when executed by the one or more processors 1120, cause the one or more processors 1120 to perform the method 700 described with respect to FIG. 7, or any aspect related to it, and/or the method 900 described with respect to FIG. 9, or any aspect related to it. Note that reference to a processor performing a function of communications device 1100 may include one or more processors performing that function of communications device 1100.

As shown in FIG. 11, the communications device 1100 may include circuitry for establishing, using an LBT procedure, a COT having a set of shareable resources (circuitry 1135).

As shown in FIG. 11, the communications device 1100 may include, stored in computer-readable medium/memory 1130, code for establishing, using an LBT procedure, a COT having a set of shareable resources (code 1140).

As shown in FIG. 11, the communications device 1100 may include circuitry for transmitting COT sharing information (circuitry 1145). The COT sharing information may be transmitted to a second UE and may indicate the set of shareable resources to be shared with the second UE, the COT sharing information comprising a first COT sharing ID, the first COT sharing ID indicating a first unicast mode source ID associated with the first UE and a first unicast mode destination ID associated with the second UE, the first unicast mode destination ID identifying the second UE as eligible for sharing the set of shareable resources. The COT sharing information may indicate the set of shareable resources and may comprise a first COT sharing ID that indicates a first group destination ID associated with a first group of one or more eligible COT sharing UEs.

As shown in FIG. 11, the communications device 1100 may include, stored in computer-readable medium/memory 1130, code for transmitting COT sharing information (code 1150). The COT sharing information may be transmitted to a second UE and may indicate the set of shareable resources to be shared with the second UE, the COT sharing information comprising a first COT sharing ID, the first COT sharing ID indicating a first unicast mode source ID associated with the first UE and a first unicast mode destination ID associated with the second UE, the first unicast mode destination ID identifying the second UE as eligible for sharing the set of shareable resources. The COT sharing information may indicate the set of shareable resources and may comprise a first COT sharing ID that indicates a first group destination ID associated with a first group of one or more eligible COT sharing UEs.

Various components of the communications device 1100 may provide means for performing the method 700 described with respect to FIG. 7, or any aspect related to it, and/or the method 900 described with respect to FIG. 9, or any aspect related to it. For example, means for transmitting, sending, or outputting for transmission may include the transceiver(s) 254 and/or antenna(s) 252 of the UE 120 and/or transceiver 1108 and antenna 1110 of the communications device 1100 in FIG. 11. Means for receiving or obtaining may include the transceiver(s) 254 and/or antenna(s) 252 of the UE 120 and/or transceiver 1108 and antenna 1110 of the communications device 1100 in FIG. 11.

In certain aspects, the computer-readable medium/memory 1130 is configured to store instructions (e.g., computer-executable code, processor-executable code) that when executed by the one or more processors 1120, cause the one or more processors 1120 to perform the method 800 described with respect to FIG. 8, or any aspect related to it, and/or the method 1000 described with respect to FIG. 10, or any aspect related to it. Note that reference to a processor performing a function of communications device 1100 may include one or more processors performing that function of communications device 1100.

As shown in FIG. 11, the communications device 1100 may include circuitry for receiving COT sharing information (block 1155). The COT sharing information may be received from a first UE and may indicate a set of shareable resources, of a COT initiated by the first UE, to be shared with the second UE, the COT sharing information comprising a first COT sharing ID, the first COT sharing ID indicating a first unicast mode source ID associated with the first UE and a first unicast mode destination ID associated with the second UE, the first unicast mode destination ID identifying the second UE as eligible for sharing the set of shareable resources. The COT sharing information may indicate a set of shareable resources, of a COT initiated by the first UE, to be shared with the second UE, the COT sharing information comprising a first COT sharing ID that indicates a first group destination ID associated with a first group of one or more eligible COT sharing UEs, the first group including the second UE.

As shown in FIG. 11, the communications device 1100 may include, stored in computer-readable medium/memory 1130, code for receiving COT sharing information (code 1160). The COT sharing information may be received from a first UE and may indicate a set of shareable resources, of a COT initiated by the first UE, to be shared with the second UE, the COT sharing information comprising a first COT sharing ID, the first COT sharing ID indicating a first unicast mode source ID associated with the first UE and a first unicast mode destination ID associated with the second UE, the first unicast mode destination ID identifying the second UE as eligible for sharing the set of shareable resources. The COT sharing information may indicate a set of shareable resources, of a COT initiated by the first UE, to be shared with the second UE, the COT sharing information comprising a first COT sharing ID that indicates a first group destination ID associated with a first group of one or more eligible COT sharing UEs, the first group including the second UE.

As shown in FIG. 11, the communications device 1100 may include circuitry for communicating using the set of shareable resources based on the COT sharing information (circuitry 1165).

As shown in FIG. 11, the communications device 1100 may include, stored in computer-readable medium/memory 1130, code for communicating using the set of shareable resources based on the COT sharing information (code 1170).

Various components of the communications device 1100 may provide means for performing the method 800 described with respect to FIG. 8, or any aspect related to it, and/or the method 1000 described with respect to FIG. 10, or any aspect related to it. For example, means for transmitting, sending, or outputting for transmission may include the transceiver(s) 254 and/or antenna(s) 252 of the UE 120 and/or transceiver 1108 and antenna 1110 of the communications device 1100 in FIG. 11. Means for receiving or obtaining may include the transceiver(s) 254 and/or antenna(s) 252 of the UE 120 and/or transceiver 1108 and antenna 1110 of the communications device 1100 in FIG. 11.

FIG. 11 is provided as an example. Other examples may differ from what is described in connection with FIG. 11.

The following provides an overview of some Aspects of the present disclosure:

Aspect 1: A method of wireless communication performed by a first user equipment (UE), comprising: establishing, using a listen-before-talk (LBT) procedure, a channel occupancy time (COT) having a set of shareable resources; and transmitting, to a second UE, COT sharing information indicating the set of shareable resources to be shared with the second UE, the COT sharing information comprising a first COT sharing identifier (ID), the first COT sharing ID indicating a first unicast mode source ID associated with the first UE and a first unicast mode destination ID associated with the second UE, the first unicast mode destination ID identifying the second UE as eligible for sharing the set of shareable resources.

Aspect 2: The method of Aspect 1, wherein the first COT sharing ID comprises the first unicast mode source ID and the first unicast mode destination ID.

Aspect 3: The method of either of claims 1 or 2, wherein the first unicast mode source ID comprises a first layer 2 ID and the first unicast mode destination ID comprises a second layer 2 ID.

Aspect 4: The method of either of claims 1 or 2, wherein the first unicast mode source ID comprises a first layer 1 ID and the first unicast mode destination ID comprises a second layer 1 ID.

Aspect 5: The method of any of Aspects 1-4, wherein the first COT sharing ID includes at least one of a truncated source ID associated with the first unicast mode source ID or a truncated destination ID associated with the first unicast mode destination ID.

Aspect 6: The method of Aspect 1, wherein the first COT sharing ID comprises: a table ID associated with a configured ID mapping table, wherein the table ID is associated with an application layer ID, and a table index associated with a mapping between the table index and an ID pair, the ID pair comprising the first unicast mode source ID and the first unicast mode destination ID.

Aspect 7: The method of Aspect 6, wherein the ID mapping table indicates the mapping.

Aspect 8: The method of either of Aspects 6 or 7, further comprising transmitting configuration information that comprises the ID mapping table.

Aspect 9: The method of Aspect 8, wherein transmitting the configuration information comprises transmitting a PC-5 radio resource control communication that comprises the configuration information.

Aspect 10: The method of any of Aspects 1-9, wherein the COT sharing information further comprises a second COT sharing ID, the second COT sharing ID indicating a second unicast mode source ID, different from the first unicast mode source ID, associated with the first UE, and a second unicast mode destination ID, different from the first unicast mode destination ID, associated with a third UE.

Aspect 11: A method of wireless communication performed by a second user equipment (UE), comprising: receiving, from a first UE, channel occupancy time (COT) sharing information indicating a set of shareable resources, of a COT initiated by the first UE, to be shared with the second UE, the COT sharing information comprising a first COT sharing identifier (ID), the first COT sharing ID indicating a first unicast mode source ID associated with the first UE and a first unicast mode destination ID associated with the second UE, the first unicast mode destination ID identifying the second UE as eligible for sharing the set of shareable resources; and communicating using the set of shareable resources based on the COT sharing information.

Aspect 12: The method of Aspect 11, wherein the first COT sharing ID comprises the first unicast mode source ID and the first unicast mode destination ID.

Aspect 13: The method of either of claims 11 or 12, wherein the first unicast mode source ID comprises a first layer 2 ID and the first unicast mode destination ID comprises a second layer 2 ID.

Aspect 14: The method of either of claims 11 or 12, wherein the first unicast mode source ID comprises a first layer 1 ID and the first unicast mode destination ID comprises a second layer 1 ID.

Aspect 15: The method of any of Aspects 11-14, wherein the first unicast mode source ID comprises a layer 1 source ID, the method further comprising receiving, during the COT, a communication from the first UE, the communication comprising a layer 2 source ID associated with the first UE, wherein an identification of the first UE as a COT initiator of the COT is based on the layer 2 source ID.

Aspect 16: The method of any of Aspects 11-15, wherein the first COT sharing ID comprises at least one of a truncated source ID associated with the first unicast mode source ID or a truncated destination ID associated with the first unicast mode destination ID.

Aspect 17: The method of Aspect 11, wherein the first COT sharing ID comprises: a table ID associated with a configured ID mapping table, wherein the table ID is associated with an application layer ID, and a table index associated with a mapping between the table index and an ID pair, the ID pair comprising the first unicast mode source ID and the first unicast mode destination ID.

Aspect 18: The method of Aspect 17, wherein the ID mapping table indicates the mapping.

Aspect 19: The method of either of Aspects 17 or 18, wherein the ID mapping table indicates that the first UE is a COT initiator of the COT.

Aspect 20: The method of any of Aspects 17-19, further comprising receiving configuration information that comprises the ID mapping table.

Aspect 21: The method of Aspect 20, wherein receiving the configuration information comprises receiving a PC-5 radio resource control communication that comprises the configuration information.

Aspect 22: The method of any of Aspects 11-21, wherein the COT sharing information further comprises a second COT sharing ID, the second COT sharing ID indicating a second unicast mode source ID, different from the first unicast mode source ID, associated with the first UE and a second unicast mode destination ID, different from the first unicast mode destination ID, associated with a third UE.

Aspect 23: A method of wireless communication performed by a first user equipment (UE), comprising: establishing, using a listen-before-talk (LBT) procedure, a channel occupancy time (COT) having a set of shareable resources; and transmitting COT sharing information indicating the set of shareable resources, the COT sharing information comprising a first COT sharing identifier (ID) that indicates a first group destination ID associated with a first group of one or more eligible COT sharing UEs.

Aspect 24: The method of Aspect 23, wherein the first group destination ID is associated with groupcast mode communications.

Aspect 25: The method of either of claims 23 or 24, wherein the first COT sharing ID further comprises a COT initiator ID associated with the first UE.

Aspect 26: The method of Aspect 25, wherein the COT initiator ID is associated with an application layer ID.

Aspect 27: The method of any of Aspects 23-26, wherein the first group destination ID is associated with the first UE.

Aspect 28: The method of any of Aspects 23-27, wherein the COT sharing information further comprises a second COT sharing ID, the second COT sharing ID indicating at least one of a unicast mode source ID associated with the first UE or a unicast mode destination ID associated with a second UE.

Aspect 29: The method of any of Aspects 23-27, wherein the COT sharing information further includes a second COT sharing ID that indicates a second group destination ID associated with a second group of one or more eligible COT sharing UEs.

Aspect 30: The method of Aspect 29, wherein the second COT sharing ID further comprises a COT initiator ID associated with the first UE.

Aspect 31: The method of any of Aspects 23-30, further comprising transmitting configuration information that configures the first group.

Aspect 32: The method of Aspect 31, wherein transmitting the configuration information comprises transmitting a PC-5 radio resource control communication that includes the configuration information.

Aspect 33: The method of any of Aspects 23-32, wherein the first COT sharing ID comprises the group destination ID and one or more COT sharing eligibility indications, wherein each COT sharing eligibility indication of the one or more COT sharing eligibility indications is associated with a respective UE of the first group of one or more UEs.

Aspect 34: A method of wireless communication performed by a second user equipment (UE), comprising: receiving, from a first UE, channel occupancy time (COT) sharing information indicating a set of shareable resources, of a COT initiated by the first UE, to be shared with the second UE, the COT sharing information comprising a first COT sharing identifier (ID) that indicates a first group destination ID associated with a first group of one or more eligible COT sharing UEs, the first group including the second UE; and communicating using the set of shareable resources based on the COT sharing information.

Aspect 35: The method of Aspect 34, wherein the first group destination ID is associated with groupcast mode communications.

Aspect 36: The method of either of claims 34 or 35, wherein the first COT sharing ID further comprises a COT initiator ID associated with the first UE.

Aspect 37: The method of Aspect 36, wherein the COT initiator ID is associated with an application layer ID.

Aspect 38: The method of any of Aspects 34-37, wherein the first group destination ID is associated with the first UE.

Aspect 39: The method of any of Aspects 34-38, wherein the COT sharing information further comprises a second COT sharing ID, the second COT sharing ID indicating at least one of a unicast mode source ID associated with the first UE or a unicast mode destination ID associated with the second UE.

Aspect 40: The method of any of Aspects 34-38, wherein the COT sharing information further comprises a second COT sharing ID that indicates a second group destination ID associated with a second group of one or more eligible COT sharing UEs.

Aspect 41: The method of Aspect 40, wherein the second COT sharing ID further comprises a COT initiator ID associated with the first UE.

Aspect 42: The method of any of Aspects 34-41, further comprising receiving configuration information that configures the first group.

Aspect 43: The method of Aspect 42, wherein receiving the configuration information comprises receiving a PC-5 radio resource control communication that includes the configuration information.

Aspect 44: The method of any of Aspects 34-43, wherein the first COT sharing ID comprises the group destination ID and one or more COT sharing eligibility indications, wherein each COT sharing eligibility indication of the one or more COT sharing eligibility indications is associated with a respective UE of the first group of one or more UEs.

Aspect 45: An apparatus for wireless communication at a device, comprising a processor; memory coupled with the processor; and instructions stored in the memory and executable by the processor to cause the apparatus to perform the method of one or more of Aspects 1-10.

Aspect 46: A device for wireless communication, comprising a memory and one or more processors coupled to the memory, the one or more processors configured to perform the method of one or more of Aspects 1-10.

Aspect 47: An apparatus for wireless communication, comprising at least one means for performing the method of one or more of Aspects 1-10.

Aspect 48: A non-transitory computer-readable medium storing code for wireless communication, the code comprising instructions executable by a processor to perform the method of one or more of Aspects 1-10.

Aspect 49: A non-transitory computer-readable medium storing a set of instructions for wireless communication, the set of instructions comprising one or more instructions that, when executed by one or more processors of a device, cause the device to perform the method of one or more of Aspects 1-10.

Aspect 50: An apparatus for wireless communication at a device, comprising a processor; memory coupled with the processor; and instructions stored in the memory and executable by the processor to cause the apparatus to perform the method of one or more of Aspects 11-22.

Aspect 51: A device for wireless communication, comprising a memory and one or more processors coupled to the memory, the one or more processors configured to perform the method of one or more of Aspects 11-22.

Aspect 52: An apparatus for wireless communication, comprising at least one means for performing the method of one or more of Aspects 11-22.

Aspect 53: A non-transitory computer-readable medium storing code for wireless communication, the code comprising instructions executable by a processor to perform the method of one or more of Aspects 11-22.

Aspect 54: A non-transitory computer-readable medium storing a set of instructions for wireless communication, the set of instructions comprising one or more instructions that, when executed by one or more processors of a device, cause the device to perform the method of one or more of Aspects 11-22.

Aspect 55: An apparatus for wireless communication at a device, comprising a processor; memory coupled with the processor; and instructions stored in the memory and executable by the processor to cause the apparatus to perform the method of one or more of Aspects 23-33.

Aspect 56: A device for wireless communication, comprising a memory and one or more processors coupled to the memory, the one or more processors configured to perform the method of one or more of Aspects 23-33.

Aspect 57: An apparatus for wireless communication, comprising at least one means for performing the method of one or more of Aspects 23-33.

Aspect 58: A non-transitory computer-readable medium storing code for wireless communication, the code comprising instructions executable by a processor to perform the method of one or more of Aspects 23-33.

Aspect 59: A non-transitory computer-readable medium storing a set of instructions for wireless communication, the set of instructions comprising one or more instructions that, when executed by one or more processors of a device, cause the device to perform the method of one or more of Aspects 23-33.

Aspect 60: An apparatus for wireless communication at a device, comprising a processor; memory coupled with the processor; and instructions stored in the memory and executable by the processor to cause the apparatus to perform the method of one or more of Aspects 34-44.

Aspect 61: A device for wireless communication, comprising a memory and one or more processors coupled to the memory, the one or more processors configured to perform the method of one or more of Aspects 34-44.

Aspect 62: An apparatus for wireless communication, comprising at least one means for performing the method of one or more of Aspects 34-44.

Aspect 63: A non-transitory computer-readable medium storing code for wireless communication, the code comprising instructions executable by a processor to perform the method of one or more of Aspects 34-44.

Aspect 64: A non-transitory computer-readable medium storing a set of instructions for wireless communication, the set of instructions comprising one or more instructions that, when executed by one or more processors of a device, cause the device to perform the method of one or more of Aspects 34-44.

The foregoing disclosure provides illustration and description but is not intended to be exhaustive or to limit the aspects to the precise forms disclosed.

Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules, and circuits described in connection with the present disclosure may be implemented or performed with a general purpose processor, a digital signal processor (DSP), an application-specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices (e.g., a combination of a DSP and a microprocessor, a plurality of microprocessors, one or more microprocessors in conjunction with a DSP core, a system on a chip (SoC), or any other such configuration).

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or a processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A first user equipment (UE) configured for wireless communications, comprising:
a memory comprising processor-executable instructions; and
a processor configured to execute the processor-executable instructions and cause the first UE to:
establish, using a listen-before-talk (LBT) procedure, a channel occupancy time (COT) having a set of shareable resources; and
transmit, to a second UE, COT sharing information indicating the set of shareable resources to be shared with the second UE, the COT sharing information comprising a first COT sharing identifier (ID), the first COT sharing ID indicating a first unicast mode source ID associated with the first UE and a first unicast mode destination ID associated with the second UE, the first unicast mode destination ID identifying the second UE as eligible for sharing the set of shareable resources.

2. The first UE of claim 1, wherein the first COT sharing ID comprises the first unicast mode source ID and the first unicast mode destination ID.

3. The first UE of claim 1, wherein the first unicast mode source ID comprises a first layer 2 ID and the first unicast mode destination ID comprises a second layer 2 ID.

4. The first UE of claim 1, wherein the first unicast mode source ID comprises a first layer 1 ID and the first unicast mode destination ID comprises a second layer 1 ID.

5. The first UE of claim 1, wherein the first COT sharing ID includes at least one of a truncated source ID associated with the first unicast mode source ID or a truncated destination ID associated with the first unicast mode destination ID.

6. The first UE of claim 1, wherein the first COT sharing ID comprises:
a table ID associated with a configured ID mapping table, wherein the table ID is associated with an application layer ID, and
a table index associated with a mapping between the table index and an ID pair, the ID pair comprising the first unicast mode source ID and the first unicast mode destination ID.

7. The first UE of claim 6, wherein the ID mapping table indicates the mapping.

8. The first UE of claim 6, wherein the processor is configured to execute the processor-executable instructions and further cause the first UE to transmit configuration information that comprises the ID mapping table.

9. The first UE of claim 8, wherein to transmit the configuration information, the processor is configured to cause the first UE to transmit a PC-5 radio resource control communication that comprises the configuration information.

10. The first UE of claim 1, wherein the COT sharing information further comprises a second COT sharing ID, the second COT sharing ID indicating a second unicast mode source ID, different from the first unicast mode source ID, associated with the first UE, and a second unicast mode destination ID, different from the first unicast mode destination ID, associated with a third UE.

11. A second user equipment (UE) configured for wireless communications, comprising:
a memory comprising processor-executable instructions; and
a processor configured to execute the processor-executable instructions and cause the second UE to:
receive, from a first UE, channel occupancy time (COT) sharing information indicating a set of shareable resources, of a COT initiated by the first UE, to be shared with the second UE, the COT sharing information comprising a first COT sharing identifier (ID), the first COT sharing ID indicating a first unicast mode source ID associated with the first UE and a first unicast mode destination ID associated with the second UE, the first unicast mode destination ID identifying the second UE as eligible for sharing the set of shareable resources; and
communicate using the set of shareable resources based on the COT sharing information.

12. The second UE of claim 11, wherein the first COT sharing ID comprises the first unicast mode source ID and the first unicast mode destination ID.

13. The second UE of claim 11, wherein the first unicast mode source ID comprises a layer 1 source ID, and wherein the processor is further configured to execute the processor-executable instructions and further cause the second UE to receive, during the COT, a communication from the first UE, the communication comprising a layer 2 source ID associated with the first UE, wherein an identification of the first UE as a COT initiator of the COT is based on the layer 2 source ID.

14. The second UE of claim 11, wherein the first COT sharing ID comprises at least one of a truncated source ID associated with the first unicast mode source ID or a truncated destination ID associated with the first unicast mode destination ID.

15. The second UE of claim 11, wherein the first COT sharing ID comprises:
a table ID associated with a configured ID mapping table, wherein the table ID is associated with an application layer ID, and
a table index associated with a mapping between the table index and an ID pair, the ID pair comprising the first unicast mode source ID and the first unicast mode destination ID.

16. The second UE of claim 11, wherein the COT sharing information further comprises a second COT sharing ID, the second COT sharing ID indicating a second unicast mode source ID, different from the first unicast mode source ID, associated with the first UE and a second unicast mode destination ID, different from the first unicast mode destination ID, associated with a third UE.

17-30. (canceled)

31. A method for wireless communications by a first user equipment (UE), comprising:
establishing, using a listen-before-talk (LBT) procedure, a channel occupancy time (COT) having a set of shareable resources; and
transmitting, to a second UE, COT sharing information indicating the set of shareable resources to be shared with the second UE, the COT sharing information comprising a first COT sharing identifier (ID), the first COT sharing ID indicating a first unicast mode source ID associated with the first UE and a first unicast mode destination ID associated with the second UE, the first unicast mode destination ID identifying the second UE as eligible for sharing the set of shareable resources.
